(19) United States
(12) Patent Application Publication
(10) Pub. No.: US 2025/0047336 A1
(43) Pub. Date: Feb. 6, 2025

(54) ORBITAL ANGULAR MOMENTUM MULTIPLEXING USING DIFFERENT QUANTITIES OF TRANSMIT AND RECEIVE ANTENNA SUBARRAYS

(71) Applicant: QUALCOMM Incorporated, San Diego, CA (US)

(72) Inventors: Danlu ZHANG, San Diego, CA (US); Meilong JIANG, Westfield, NJ (US); Yu ZHANG, San Diego, CA (US); Juergen CEZANNE, Ocean Township, NJ (US); Junyi LI, Greentown, PA (US); Ashwin SAMPATH, Skillman, NJ (US); Sony AKKARAKARAN, Poway, CA (US)

(21) Appl. No.: 18/717,396

(22) PCT Filed: Feb. 25, 2022
(86) PCT No.: PCT/CN2022/077918

§ 371 Date: Jun. 6, 2024

(51) Int. Cl. H04B 7/0456

(52) U.S. Cl. CPC H04B 7/0456

(57) ABSTRACT

Methods, systems, and devices for wireless communication are described. Some wireless communications systems may support orbital angular momentum (OAM) communications between a transmitting device and a receiving device. The transmitting device may generate signals for transmission to the receiving device via a transmitter circle that includes a first quantity of antenna arrays. The transmitting device may transmit the signals using the transmitter circle based on multiple sets of OAM weights, where each signal may be associated with a respective set of OAM weights. The receiving device may receive the signals using a receiver circle that includes a second quantity of antenna arrays that is different than the first quantity. The receiving device may decode the signals based on multiple sets of OAM weights. The sets of OAM weights at the transmitting device and the receiving device may be based on the first quantity being different than the second quantity.

### CROSS REFERENCE

The present application is a 371 national phase filing of International PCT Application No. PCT/CN2022/077918 by ZHANG et al., entitled “ORBITAL ANGULAR MOMENTUM MULTIPLEXING USING DIFFERENT QUANTITIES OF TRANSMIT AND RECEIVE ANTENNA SUBARRAYS,” filed Feb. 25, 2022, which is assigned to the assignee hereof, and which is expressly incorporated by reference in its entirety herein.

### FIELD OF TECHNOLOGY

The following relates to wireless communication, including orbital angular momentum (OAM) multiplexing using different quantities of transmit and receive antenna subarrays.

### BACKGROUND

Wireless communications systems are widely deployed to provide various types of communication content such as voice, video, packet data, messaging, broadcast, and so on. These systems may be capable of supporting communicate on with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations or one or more network access nodes, each simultaneously supporting communication for multiple communication devices, which may be otherwise known as user equipment (UE).

In some wireless communications systems, wireless devices, such as base stations, UEs, network devices, or any combination thereof, may communicate directionally, for example, using beams to orient communication signals over one or more directions. In some systems, such as in orbital angular momentum (OAM)-capable communications systems, the wireless devices may communicate using OAM beams, which, in addition to providing signal directionality, may also provide additional dimensions for signal multiplexing. The OAM beams may be generated using one or more antenna subarrays disposed in a circle at each wireless device.

### SUMMARY

The described techniques relate to improved methods, systems, devices, and apparatuses that support orbital angular momentum (OAM) multiplexing using different quantities of transmit and receive antenna subarrays. Generally, the described techniques provide for a transmitting device that includes a first quantity of antenna subarrays to support OAM communications with a receiving device that includes a second quantity of antenna subarrays different from the first quantity. The devices may each include a circular antenna array that includes the respective quantities of antenna subarrays. The circular antenna array at the transmitting and receiving devices may be referred to as a transmitter circle and a receiver circle, respectively. Each antenna subarray within a circular antenna array may include one or more antenna elements. In some examples, the first quantity of antenna arrays in the first circular antenna array may be an integer multiple of the second quantity of antenna subarrays within the second circular antenna array, or vice versa.

The transmitting device may generate multiple OAM signals for transmission to the receiving device via the transmitter circle. The transmitting device may transmit the OAM signals concurrently to the second device using the transmitter circle and based on one or more sets of OAM weights. Each set of OAM weights may be referred to as an OAM weighting vector and may correspond to a respective OAM mode. The transmitting device may transmit each signal using a respective OAM mode and corresponding OAM weighting vector. The receiving device may receive and decode the OAM signals using the receiver circle and based on multiple sets of OAM weights and corresponding OAM modes at the receiving device. In some examples, the sets of OAM weights at the transmitting device, the sets of OAM weights at the receiving device, or both may be based on the receiver circle and the transmitter circle having different quantities of antenna subarrays.

A method for wireless communication at a first device is described. The method may include generating one or more signals for transmission from the first device to a second device via a first circular antenna array that includes a first quantity of antenna subarrays, where each antenna subarray of the first circular antenna array includes one or more antenna elements and transmitting the one or more signals to the second device using the first circular antenna array and based on a set of multiple OAM vectors, where each signal of the one or more signals is associated with a respective OAM vector of the set of multiple OAM vectors, and where the set of multiple OAM vectors is based on a second circular antenna array at the second device including a second quantity of antenna subarrays that is different than the first quantity of antenna subarrays included in the first circular antenna array.

An apparatus for wireless communication is described. The apparatus may include a processor of a first device, a first circular antenna array that includes a first quantity of antenna subarrays, where each antenna subarray of the first circular antenna array includes one or more antenna elements, and memory coupled with the processor. The memory and the processor may be configured to cause the apparatus to generate one or more signals for transmission from the first device to a second device via a first circular antenna array that includes a first quantity of antenna subarrays, where each antenna subarray of the first circular antenna array includes one or more antenna elements and transmit the one or more signals to the second device using the first circular antenna array and based on a set of multiple OAM vectors, where each signal of the one or more signals is associated with a respective OAM vector of the set of multiple OAM vectors, and where the set of multiple OAM vectors is based on a second circular antenna array at the second device including a second quantity of antenna subarrays that is different than the first quantity of antenna subarrays included in the first circular antenna array.

Another apparatus for wireless communication is described. The apparatus may include means for generating one or more signals for transmission from the first device to a second device via a first circular antenna array that includes a first quantity of antenna subarrays, where each antenna subarray of the first circular antenna array includes one or more antenna elements and means for transmitting the one or more signals to the second device using the first circular antenna array and based on a set of multiple OAM vectors, where each signal of the one or more signals is associated with a respective OAM vector of the set of multiple OAM vectors, and where the set of multiple OAM vectors is based on a second circular antenna array at the second device including a second quantity of antenna subarrays that is different than the first quantity of antenna subarrays included in the first circular antenna array.

A non-transitory computer-readable medium storing code for wireless communication at a first device is described. The code may include instructions executable by a processor to generate one or more signals for transmission from the first device to a second device via a first circular antenna array that includes a first quantity of antenna subarrays, where each antenna subarray of the first circular antenna array includes one or more antenna elements and transmit the one or more signals to the second device using the first circular antenna array and based on a set of multiple OAM vectors, where each signal of the one or more signals is associated with a respective OAM vector of the set of multiple OAM vectors, and where the set of multiple OAM vectors is based on a second circular antenna array at the second device including a second quantity of antenna subarrays that is different than the first quantity of antenna subarrays included in the first circular antenna array.

In some examples of the method, apparatuses, and non-transitory computer-readable medium described herein, the first quantity of antenna subarrays included in the first circular antenna array being an integer multiple of the second quantity of antenna subarrays included in the second circular antenna array and the second quantity of antenna subarrays included in the second circular antenna array being an integer multiple of the first quantity of antenna subarrays included in the first circular antenna array.

In some examples of the method, apparatuses, and non-transitory computer-readable medium described herein, a quantity of OAM vectors within the set of multiple OAM vectors may be equal to a minimum of the first quantity and the second quantity.

In some examples of the method, apparatuses, and non-transitory computer-readable medium described herein, the first quantity of antenna subarrays of the first circular antenna array may be less than the second quantity of antenna subarrays of the second circular antenna array and each OAM vector of the set of multiple OAM vectors includes a respective OAM weight for each antenna array of the first quantity of antenna subarrays based on the first quantity of antenna subarrays being less than the second quantity of antenna subarrays.

In some examples of the method, apparatuses, and non-transitory computer-readable medium described herein, the first quantity of antenna subarrays may be equal to a product of the second quantity of antenna subarrays and an integer factor and the method, apparatuses, and non-transitory computer-readable medium may include further operations, features, means, or instructions for grouping a second set of multiple OAM vectors into one or more groups based on the integer factor, where each group of the one or more groups includes a same quantity of OAM vectors, the same quantity equal to the integer factor and combining OAM vectors in each group to obtain the set of multiple OAM vectors.

Some examples of the method, apparatuses, and non-transitory computer-readable medium described herein may further include operations, features, means, or instructions for receiving, from the second device, a set of multiple reference signals using each antenna subarray of the first quantity of antenna subarrays within the first circular antenna array of the first device and estimating a set of multiple sets of channel gains based on the set of multiple reference signals, each set of channel gains of the set of multiple sets of channel gains including channel gains between antenna subarrays of the second quantity of antenna subarrays within the second circular antenna array of the second device and antenna subarrays of the first quantity of antenna subarrays within the first circular antenna array of the first device, and where the combining may be based on the set of multiple sets of channel gains.

Some examples of the method, apparatuses, and non-transitory computer-readable medium described herein may further include operations, features, means, or instructions for transmitting, to the second device, a set of multiple reference signals using each antenna subarray of the first quantity of antenna subarrays within the first circular antenna array of the first device and receiving, from the second device, an indication of a set of multiple sets of channel gains based on the set of multiple reference signals, each set of channel gains of the set of multiple sets of channel gains including channel gains between antenna subarrays of the second quantity of antenna subarrays within the second circular antenna array of the second device and antenna subarrays of the first quantity of antenna subarrays within the first circular antenna array of the first device, and where the combining may be based on the set of multiple sets of channel gains.

In some examples of the method, apparatuses, and non-transitory computer-readable medium described herein, each antenna subarray of the first quantity of antenna subarrays within the first circular antenna array of the first device may be located at a respective first angular offset relative to a first axis that bisects the first circular antenna array and each antenna subarray of the second quantity of antenna subarrays within the second circular antenna array of the second device may be located at a respective second angular offset relative to a second axis that bisects the second circular antenna array and may be parallel to the first axis, each respective second angular offset different than each respective first angular offset, where a difference between the respective first angular offset for a first antenna subarray of the first quantity of antenna subarrays and the respective second angular offset for a second antenna subarray of the second quantity of antenna subarrays may be based on the first quantity of antenna subarrays and the second quantity of antenna subarrays.

In some examples of the method, apparatuses, and non-transitory computer-readable medium described herein, the difference may be based on a ratio between the first quantity and a minimum of the first quantity and the second quantity.

Some examples of the method, apparatuses, and non-transitory computer-readable medium described herein may further include operations, features, means, or instructions for transmitting, to the second device, signaling that indicates the first quantity of antenna subarrays within the first circular antenna array of the first device, receiving, from the second device, signaling that indicates the second quantity of antenna subarrays within the second circular antenna array of the second device, and any combination thereof.

Some examples of the method, apparatuses, and non-transitory computer-readable medium described herein may further include operations, features, means, or instructions for determining the first quantity of antenna subarrays of the first circular antenna array based on a condition of a channel between the first device and the second device, a type of the first device, a capability of the first device, power consumption of the first device, or any combination thereof.

A method for wireless communication at a second device is described. The method may include receiving one or more signals from a first device using a second circular antenna array that includes a second quantity of antenna subarrays, where each antenna subarray of the second circular antenna array includes one or more antenna elements and decoding the one or more signals received using the second circular antenna array based on a set of multiple OAM vectors, where each signal of the one or more signals is associated with a respective OAM vector of the set of multiple OAM vectors, and where the set of multiple OAM vectors is based on a first circular antenna array at the first device including a first quantity of antenna subarrays that is different than the second quantity of antenna subarrays included in the second circular antenna array.

Another apparatus for wireless communication is described. The apparatus may include a processor of a second device, a second circular antenna array that comprises a second quantity of antenna subarrays disposed in a circle, wherein each antenna subarray of the second circular antenna array comprises one or more antenna elements, and memory coupled with the processor. The memory and the processor configured to cause the apparatus to receive one or more signals from a first device using a second circular antenna array that includes a second quantity of antenna subarrays, where each antenna subarray of the second circular antenna array includes one or more antenna elements and decode the one or more signals received using the second circular antenna array based on a set of multiple OAM vectors, where each signal of the one or more signals is associated with a respective OAM vector of the set of multiple OAM vectors, and where the set of multiple OAM vectors is based on a first circular antenna array at the first device including a first quantity of antenna subarrays that is different than the second quantity of antenna subarrays included in the second circular antenna array.

Another apparatus for wireless communication is described. The apparatus may include means for receiving one or more signals from a first device using a second circular antenna array that includes a second quantity of antenna subarrays, where each antenna subarray of the second circular antenna array includes one or more antenna elements and means for decoding the one or more signals received using the second circular antenna array based on a set of multiple OAM vectors, where each signal of the one or more signals is associated with a respective OAM vector of the set of multiple OAM vectors, and where the set of multiple OAM vectors is based on a first circular antenna array at the first device including a first quantity of antenna subarrays that is different than the second quantity of antenna subarrays included in the second circular antenna array.

A non-transitory computer-readable medium storing code for wireless communication at a second device is described. The code may include instructions executable by a processor to receive one or more signals from a first device using a second circular antenna array that includes a second quantity of antenna subarrays, where each antenna subarray of the second circular antenna array includes one or more antenna elements and decode the one or more signals received using the second circular antenna array based on a set of multiple OAM vectors, where each signal of the one or more signals is associated with a respective OAM vector of the set of multiple OAM vectors, and where the set of multiple OAM vectors is based on a first circular antenna array at the first device including a first quantity of antenna subarrays that is different than the second quantity of antenna subarrays included in the second circular antenna array.

In some examples of the method, apparatuses, and non-transitory computer-readable medium described herein, the set of multiple OAM vectors may be based on the first quantity of antenna subarrays included in the first circular antenna array being an integer multiple of the second quantity of antenna subarrays included in the second circular antenna array or the second quantity of antenna subarrays included in the second circular antenna array being an integer multiple of the first quantity of antenna subarrays included in the first circular antenna array.

In some examples of the method, apparatuses, and non-transitory computer-readable medium described herein, a quantity of OAM vectors within the set of multiple OAM vectors may be equal to a minimum of the first quantity and the second quantity.

In some examples of the method, apparatuses, and non-transitory computer-readable medium described herein, the second quantity of antenna subarrays of the second circular antenna array may be less than the first quantity of antenna subarrays of the first circular antenna array and each OAM vector of the set of multiple OAM vectors includes a respective OAM weight for each antenna subarray of the second quantity of antenna subarrays based on the second quantity of antenna subarrays being less than the first quantity of antenna subarrays.

In some examples of the method, apparatuses, and non-transitory computer-readable medium described herein, the second quantity of antenna subarrays may be equal to a product of the first quantity of antenna subarrays and an integer factor and the method, apparatuses, and non-transitory computer-readable medium may include further operations, features, means, or instructions for grouping a second set of multiple OAM vectors into one or more groups based on the integer factor, where each group of the one or more groups includes a same quantity of OAM vectors, the same quantity equal to the integer factor and combining OAM vectors in each group to obtain the set of multiple OAM vectors.

Some examples of the method, apparatuses, and non-transitory computer-readable medium described herein may further include operations, features, means, or instructions for receiving, from the first device, a set of multiple reference signals using each antenna subarray of the second quantity of antenna subarrays within the second circular antenna array of the second device and estimating a set of multiple sets of channel gains based on the set of multiple reference signals, the set of multiple sets of channel gains including channel gains between antenna subarrays of the first quantity of antenna subarrays within the first circular antenna array of the first device and antenna subarrays of the second quantity of antenna subarrays within the second circular antenna array of the second device, and where the combining may be based on the set of multiple sets of channel gains.

Some examples of the method, apparatuses, and non-transitory computer-readable medium described herein may further include operations, features, means, or instructions for transmitting, to the first device, a set of multiple reference signals using each antenna subarray of the second quantity of antenna subarrays within the second circular antenna array of the second device and receiving, from the first device, an indication of a set of multiple sets of channel gains based on the set of multiple reference signals, each set of channel gains of the set of multiple sets of channel gains including channel gains between antenna subarrays of the first quantity of antenna subarrays within the first circular antenna array of the first device and antenna subarrays of the second quantity within the second circular antenna array of the second device, and where the combining may be based on the set of multiple sets of channel gains.

In some examples of the method, apparatuses, and non-transitory computer-readable medium described herein, each antenna subarray of the first quantity of antenna subarrays within the first circular antenna array of the first device may be located at a respective first angular offset relative to a first axis that bisects the first circular antenna array and each antenna subarray of the second quantity of antenna subarrays within the second circular antenna array of the second device may be located at a respective second angular offset relative to a second axis that bisects the second circular antenna array and may be parallel to the first axis, each respective second angular offset different than each respective first angular offset, where a difference between the respective first angular offset for a first antenna subarray of the first quantity of antenna subarrays and the respective second angular offset for a second antenna subarray of the second quantity of antenna subarrays may be based on the first quantity of antenna subarrays and the second quantity of antenna subarrays.

In some examples of the method, apparatuses, and non-transitory computer-readable medium described herein, the difference may be based on a ratio between the first quantity and a minimum of the first quantity and the second quantity.

Some examples of the method, apparatuses, and non-transitory computer-readable medium described herein may further include operations, features, means, or instructions for transmitting, to the first device, signaling that indicates the second quantity of antenna subarrays within the second circular antenna array of the second device, receiving, from the first device, signaling that indicates the first quantity of antenna subarrays within the first circular antenna array of the first device, and any combination thereof.

Some examples of the method, apparatuses, and non-transitory computer-readable medium described herein may further include operations, features, means, or instructions for determining the second quantity of antenna subarrays of the second circular antenna array based on a condition of a channel between the second device and the first device, a type of the second device, a capability of the second device, power consumption of the second device, or any combination thereof.

### BRIEF DESCRIPTION OF THE DRAWINGS

FIG. 1 illustrates an example of a wireless communications system that supports orbital angular momentum (OAM) multiplexing using different quantities of transmit and receive antenna subarrays in accordance with aspects of the present disclosure.

FIG. 2 illustrates an example of a wireless communications system that supports OAM multiplexing using different quantities of transmit and receive antenna subarrays in accordance with aspects of the present disclosure.

FIG. 3 illustrates an example of an OAM antenna array configuration that supports OAM multiplexing using different quantities of transmit and receive antenna subarrays in accordance with aspects of the present disclosure.

FIG. 4 illustrates an example of an OAM antenna array configuration that supports OAM multiplexing using different quantities of transmit and receive antenna subarrays in accordance with aspects of the present disclosure.

FIG. 5 illustrates an example of an OAM antenna array configuration that supports OAM multiplexing using different quantities of transmit and receive antenna subarrays in accordance with aspects of the present disclosure.

FIG. 6 illustrates an example of a process flow that supports OAM multiplexing using different quantities of transmit and receive antenna subarrays in accordance with aspects of the present disclosure.

FIGS. 7 and 8 show block diagrams of devices that support OAM multiplexing using different quantities of transmit and receive antenna subarrays in accordance with aspects of the present disclosure.

FIG. 9 shows a block diagram of a communications manager that supports OAM multiplexing using different quantities of transmit and receive antenna subarrays in accordance with aspects of the present disclosure.

FIG. 10 shows a diagram of a system including a UE that supports OAM multiplexing using different quantities of transmit and receive antenna subarrays in accordance with aspects of the present disclosure.

FIG. 11 shows a diagram of a system including a base station that supports OAM multiplexing using different quantities of transmit and receive antenna subarrays in accordance with aspects of the present disclosure.

FIGS. 12 through 16 show flowcharts illustrating methods that support OAM multiplexing using different quantities of transmit and receive antenna subarrays in accordance with aspects of the present disclosure.

### DETAILED DESCRIPTION

In some wireless communications systems, wireless devices, such as base stations, user equipments (UEs), network nodes, or any combination thereof, may communicate directionally, for example, using beams to orient communication signals over one or more directions. Various wireless communication schemes, such as line-of-site multiple-input multiple-output (LoS-MIMO), are being considered for advanced wireless communication systems (e.g., 6G wireless communication systems) to, for example, support high throughput over short distances. In such environments, two network nodes or other devices may communicate using one or more antenna subarrays. For example, the devices may support orbital angular momentum (OAM) multiplexing, in which a transmitting device and a receiving device may each be equipped with a respective circular antenna array that includes multiple antenna subarrays which may be referred to as a transmitter circle and a receiver circle, respectively. Each antenna subarray may include one or more antenna elements. As used herein, a transmitter circle or receiver circle may refer to a circular arrangement of antenna subarrays configured to support OAM multiplexing, and the antenna subarrays of a transmitter circle or receiver circle may but need not be disposed in a perfect circle. Either a transmitter circle or a receiver circle may alternatively be referred to as a circular antenna array, and a transmitter circle may alternatively be referred to as a circular transmitter array while a receiver circle may alternatively be referred to as a circular receiver array.

The transmitter and receiver circles may be supportive of communication between the devices according to one or more OAM modes. In some cases, a set of orthogonal OAM modes may be configured based on a quantity of antenna subarrays in both the transmitter and receiver circles. Each OAM mode may correspond to a respective vector of OAM weights to be applied to the antenna subarrays of the transmitter and receiver circles to generate and decode signals, respectively. In some cases, the quantity of antenna subarrays may differ between the transmitter circle at a transmitting device and the receiver circle at a receive device, in which case the different devices may support different quantities of OAM modes and corresponding OAM weighting vectors. However, a maximum quantity of orthogonal OAM modes that may be used for communication between the two devices may correspond to the number of antenna subarrays in the circle with the smallest quantity of antenna subarrays. As such, differences in OAM modes due to different antenna subarray quantities may result in increased complexity in decoding signals.

Techniques described herein provide for a configuration of an OAM mode and a corresponding OAM weighting vector when a quantity of antenna subarrays of a transmitter circle is different from a quantity of antenna subarrays of a receiver circle. The quantity of antenna subarrays in the receiver circle (M) may be an integer multiple of the quantity of antenna subarrays in the transmitter circle (N), or vice versa (e.g., N=KM or M=KN, where K is an integer factor greater than one). In some examples, the receiving device and the transmitting device may dynamically change the quantity of antenna subarrays used for communications based on one or more conditions or parameters of the devices. In such cases, the receiving device and the transmitting device may exchange signaling to indicate the quantity of antenna subarrays in the respective circles, where the signaling may be transmitted semi-statically or dynamically during communications.

If there are more antenna subarrays in the transmitter circle than the receiver circle, the receiving device may determine an OAM weighting vector, for example, based on an OAM mode associated with the quantity of antenna subarrays in the receiver circle. The transmitting device may be configured to divide a set of OAM modes initially including a same quantity of OAM modes as the quantity of transmitting antenna subarrays into one or more groups of OAM modes and corresponding weighting vectors. The quantity of OAM modes in each group may be the same as the integer factor between quantities of transmitter and receiver antenna subarrays. The transmitter may combine the weighting vectors in each group to calculate an average weighting value for each group. If there are more antenna subarrays in the receiver circle than the transmitter circle, the receiving device may similarly group OAM modes and combine the corresponding weighting vectors. The weighting vectors may be combined based on eigenvalues of a channel matrix associated with a channel estimation performed by the transmitting or receiving device.

Each antenna subarray of the transmitter circle may be aligned with each antenna subarray of the receiver circle, or the antenna subarrays may be offset. If the antenna subarrays are aligned, each antenna subarray of the transmitter circle may be located at a respective angular offset relative to an axis that bisects the transmitter circle and each antenna subarray of the receiver circle may be located at the same respective angular offset relative to an axis that bisects the receiver circle. To reduce aliasing and interference as described herein, an angular offset between the antenna subarrays of the transmitter circle and the antenna subarrays of the receiver circle may be configured, such that each antenna subarray of the transmitter circle is located at a respective first angular offset relative to the axis that bisects the transmitter circle and each antenna subarray of the receiver circle is located at a respective second angular offset relative to the axis that bisects the receiver circle, where each second angular offset is different than each first angular offset. The angular offsets may be based on a function of the quantity of transmitting antenna subarrays and the quantity of receiving antenna subarrays to improve communication reliability.

Aspects of the disclosure are initially described in the context of wireless communications systems. Additional aspects are described in the with reference to OAM antenna array configurations and process flows. Aspects of the disclosure are further illustrated by and described with reference to apparatus diagrams, system diagrams, and flowcharts that relate to OAM multiplexing using different quantities of transmit and receive antenna subarrays.

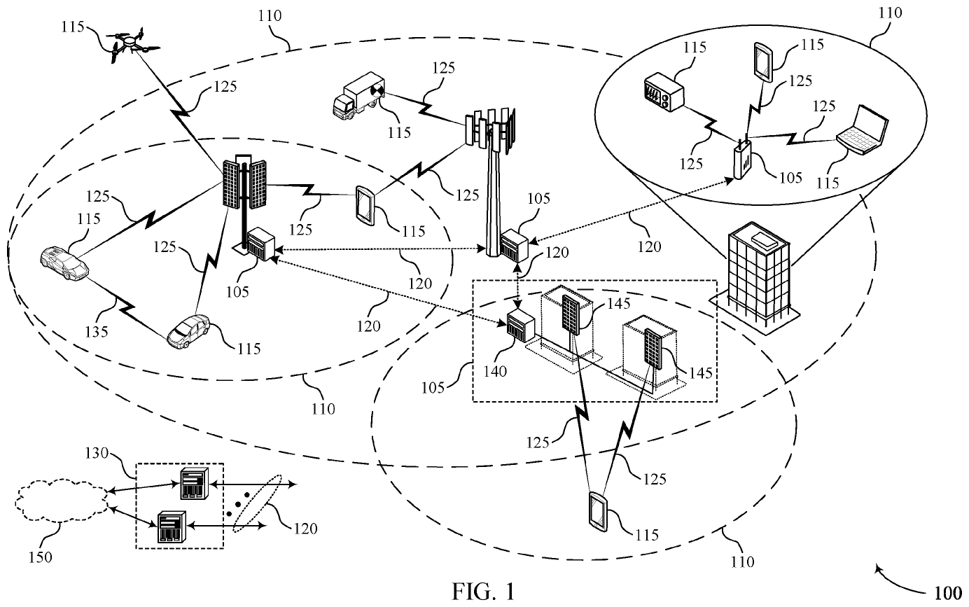

FIG. 1 illustrates an example of a wireless communications system 100 that supports OAM multiplexing using different quantities of transmit and receive antenna subarrays in accordance with aspects of the present disclosure. The wireless communications system 100 may include one or more base stations 105, one or more UEs 115, and a core network 130. In some examples, the wireless communications system 100 may be a Long Term Evolution (LTE) network, an LTE-Advanced (LTE-A) network, an LTE-A Pro network, or a New Radio (NR) network. In some examples, the wireless communications system 100 may support enhanced broadband communications, ultra-reliable communications, low latency communications, communications with low-cost and low-complexity devices, or any combination thereof.

The base stations 105 may be dispersed throughout a geographic area to form the wireless communications system 100 and may be devices in different forms or having different capabilities. The base stations 105 and the UEs 115 may wirelessly communicate via one or more communication links 125. Each base station 105 may provide a coverage area 110 over which the UEs 115 and the base station 105 may establish one or more communication links 125. The coverage area 110 may be an example of a geographic area over which a base station 105 and a UE 115 may support the communication of signals according to one or more radio access technologies.

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115, the base stations 105, or network equipment (e.g., core network nodes, relay devices, integrated access and backhaul (IAB) nodes, or other network equipment), as shown in FIG. 1.

The base stations 105 may communicate with the core network 130, or with one another, or both. For example, the base stations 105 may interface with the core network 130 through one or more backhaul links 120 (e.g., via an S1, N2, N3, or other interface). The base stations 105 may communicate with one another over the backhaul links 120 (e.g., via an X2, Xn, or other interface) either directly (e.g., directly between base stations 105), or indirectly (e.g., via core network 130), or both. In some examples, the backhaul links 120 may be or include one or more wireless links.

One or more of the base stations 105 described herein may include or may be referred to by a person having ordinary skill in the art as a base transceiver station, a radio base station, an access point, a radio transceiver, a NodeB, an eNodeB (eNB), a next-generation NodeB or a giga-NodeB (either of which may be referred to as a gNB), a Home NodeB, a Home eNodeB, or other suitable terminology.

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the base stations 105 and the network equipment including macro eNBs or gNBs, small cell eNBs or gNBs, or relay base stations, among other examples, as shown in FIG. 1.

The UEs 115 and the base stations 105 may wirelessly communicate with one another via one or more communication links 125 over one or more carriers. The term “carrier” may refer to a set of radio frequency spectrum resources having a defined physical layer structure for supporting the communication links 125. For example, a carrier used for a communication link 125 may include a portion of a radio frequency spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers.

In some examples (e.g., in a carrier aggregation configuration), a carrier may also have acquisition signaling or control signaling that coordinates operations for other carriers. A carrier may be associated with a frequency channel (e.g., an evolved universal mobile telecommunication system terrestrial radio access (E-UTRA) absolute radio frequency channel number (EARFCN)) and may be positioned according to a channel raster for discovery by the UEs 115. A carrier may be operated in a standalone mode where initial acquisition and connection may be conducted by the UEs 115 via the carrier, or the carrier may be operated in a non-standalone mode where a connection is anchored using a different carrier (e.g., of the same or a different radio access technology).

The communication links 125 shown in the wireless communications system 100 may include uplink transmissions from a UE 115 to a base station 105, or downlink transmissions from a base station 105 to a UE 115. Carriers may carry downlink or uplink communications (e.g., in an FDD mode) or may be configured to carry downlink and uplink communications (e.g., in a TDD mode).

A carrier may be associated with a particular bandwidth of the radio frequency spectrum, and in some examples the carrier bandwidth may be referred to as a “system bandwidth” of the carrier or the wireless communications system 100. For example, the carrier bandwidth may be one of a number of determined bandwidths for carriers of a particular radio access technology (e.g., 1.4, 3, 5, 10, 15, 20, 40, or 80 megahertz (MHz)). Devices of the wireless communications system 100 (e.g., the base stations 105, the UEs 115, or both) may have hardware configurations that support communications over a particular carrier bandwidth or may be configurable to support communications over one of a set of carrier bandwidths. In some examples, the wireless communications system 100 may include base stations 105 or UEs 115 that support simultaneous communications via carriers associated with multiple carrier bandwidths. In some examples, each served UE 115 may be configured for operating over portions (e.g., a sub-band, a BWP) or all of a carrier bandwidth.

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may consist of one symbol period (e.g., a duration of one modulation symbol) and one subcarrier, where the symbol period and subcarrier spacing are inversely related. The number of bits carried by each resource element may depend on the modulation scheme (e.g., the order of the modulation scheme, the coding rate of the modulation scheme, or both). Thus, the more resource elements that a UE 115 receives and the higher the order of the modulation scheme, the higher the data rate may be for the UE 115. A wireless communications resource may refer to a combination of a radio frequency spectrum resource, a time resource, and a spatial resource (e.g., spatial layers or beams), and the use of multiple spatial layers may further increase the data rate or data integrity for communications with a UE 115.

One or more numerologies for a carrier may be supported, where a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the base stations 105 or the UEs 115 may be expressed in multiples of a basic time unit which may, for example, refer to a sampling period of Tₛ=1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a number of slots. Alternatively, each frame may include a variable number of slots, and the number of slots may depend on subcarrier spacing. Each slot may include a number of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., the number of symbol periods in a TTI) may be variable. Additionally or alternatively, the smallest scheduling unit of the wireless communications system 100 may be dynamically selected (e.g., in bursts of shortened TTIs (sTTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a number of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to a number of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

Each base station 105 may provide communication coverage via one or more cells, for example a macro cell, a small cell, a hot spot, or other types of cells, or any combination thereof. The term “cell” may refer to a logical communication entity used for communication with a base station 105 (e.g., over a carrier) and may be associated with an identifier for distinguishing neighboring cells (e.g., a physical cell identifier (PCID), a virtual cell identifier (VCID), or others). In some examples, a cell may also refer to a geographic coverage area 110 or a portion of a geographic coverage area 110 (e.g., a sector) over which the logical communication entity operates. Such cells may range from smaller areas (e.g., a structure, a subset of structure) to larger areas depending on various factors such as the capabilities of the base station 105. For example, a cell may be or include a building, a subset of a building, or exterior spaces between or overlapping with geographic coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered base station 105, as compared with a macro cell, and a small cell may operate in the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A base station 105 may support one or multiple cells and may also support communications over the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a base station 105 may be movable and therefore provide communication coverage for a moving geographic coverage area 110. In some examples, different geographic coverage areas 110 associated with different technologies may overlap, but the different geographic coverage areas 110 may be supported by the same base station 105. In other examples, the overlapping geographic coverage areas 110 associated with different technologies may be supported by different base stations 105. The wireless communications system 100 may include, for example, a heterogeneous network in which different types of the base stations 105 provide coverage for various geographic coverage areas 110 using the same or different radio access technologies.

The wireless communications system 100 may support synchronous or asynchronous operation. For synchronous operation, the base stations 105 may have similar frame timings, and transmissions from different base stations 105 may be approximately aligned in time. For asynchronous operation, the base stations 105 may have different frame timings, and transmissions from different base stations 105 may, in some examples, not be aligned in time. The techniques described herein may be used for either synchronous or asynchronous operations.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a base station 105 without human intervention. In some examples, M2M communication or MTC may include communications from devices that integrate sensors or meters to measure or capture information and relay such information to a central server or application program that makes use of the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception simultaneously). In some examples, half-duplex communications may be performed at a reduced peak rate. Other power conservation techniques for the UEs 115 include entering a power saving deep sleep mode when not engaging in active communications, operating over a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may also be able to communicate directly with other UEs 115 over a device-to-device (D2D) communication link 135 (e.g., using a peer-to-peer (P2P) or D2D protocol). One or more UEs 115 utilizing D2D communications may be within the geographic coverage area 110 of a base station 105. Other UEs 115 in such a group may be outside the geographic coverage area 110 of a base station 105 or be otherwise unable to receive transmissions from a base station 105. In some examples, groups of the UEs 115 communicating via D2D communications may utilize a one-to-many (1:M) system in which each UE 115 transmits to every other UE 115 in the group. In some examples, a base station 105 facilitates the scheduling of resources for D2D communications. In other cases, D2D communications are carried out between the UEs 115 without the involvement of a base station 105.

In some systems, the D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., base stations 105) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the base stations 105 associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

Some of the network devices, such as a base station 105, may include subcomponents such as an access network entity 140, which may be an example of an access node controller (ANC). Each access network entity 140 may communicate with the UEs 115 through one or more other access network transmission entities 145, which may be referred to as radio heads, smart radio heads, or transmission/reception points (TRPs). Each access network transmission entity 145 may include one or more antenna panels. In some configurations, various functions of each access network entity 140 or base station 105 may be distributed across various network devices (e.g., radio heads and ANCs) or consolidated into a single network device (e.g., a base station 105).

The wireless communications system 100 may operate using one or more frequency bands, typically in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may also operate in a super high frequency (SHF) region using frequency bands from 3 GHz to 30 GHz, also known as the centimeter band, or in an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the base stations 105, and EHF antennas of the respective devices may be smaller and more closely spaced than UHF antennas. In some examples, this may facilitate use of antenna arrays within a device. The propagation of EHF transmissions, however, may be subject to even greater atmospheric attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed radio frequency spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. When operating in unlicensed radio frequency spectrum bands, devices such as the base stations 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A base station 105 or a UE 115 may be equipped with multiple antennas, which may be used to employ techniques such as transmit diversity, receive diversity, multiple-input multiple-output (MIMO) communications, or beamforming. The antennas of a base station 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a base station 105 may be located in diverse geographic locations. A base station 105 may have an antenna array with a number of rows and columns of antenna ports that the base station 105 may use to support beamforming of communications with a UE 115. Likewise, a UE 115 may have one or more antenna arrays that may support various MIMO or beamforming operations. Additionally or alternatively, an antenna panel may support radio frequency beamforming for a signal transmitted via an antenna port.

The base stations 105 or the UEs 115 may use MIMO communications to exploit multipath signal propagation and increase the spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry bits associated with the same data stream (e.g., the same codeword) or different data streams (e.g., different codewords). Different spatial layers may be associated with different antenna ports used for channel measurement and reporting. MIMO techniques include single-user MIMO (SU-MIMO), where multiple spatial layers are transmitted to the same receiving device, and multiple-user MIMO (MU-MIMO), where multiple spatial layers are transmitted to multiple devices.

Beamforming, which may also be referred to as spatial filtering, directional transmission, or directional reception, is a signal processing technique that may be used at a transmitting device or a receiving device (e.g., a base station 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A base station 105 or a UE 115 may use beam sweeping techniques as part of beam forming operations. For example, a base station 105 may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a base station 105 multiple times in different directions. For example, the base station 105 may transmit a signal according to different beamforming weight sets associated with different directions of transmission. Transmissions in different beam directions may be used to identify (e.g., by a transmitting device, such as a base station 105, or by a receiving device, such as a UE 115) a beam direction for later transmission or reception by the base station 105.

Some signals, such as data signals associated with a particular receiving device, may be transmitted by a base station 105 in a single beam direction (e.g., a direction associated with the receiving device, such as a UE 115). In some examples, the beam direction associated with transmissions along a single beam direction may be determined based on a signal that was transmitted in one or more beam directions. For example, a UE 115 may receive one or more of the signals transmitted by the base station 105 in different directions and may report to the base station 105 an indication of the signal that the UE 115 received with a highest signal quality or an otherwise acceptable signal quality.

In some examples, transmissions by a device (e.g., by a base station 105 or a UE 115) may be performed using multiple beam directions, and the device may use a combination of digital precoding or radio frequency beamforming to generate a combined beam for transmission (e.g., from a base station 105 to a UE 115). The UE 115 may report feedback that indicates precoding weights for one or more beam directions, and the feedback may correspond to a configured number of beams across a system bandwidth or one or more sub-bands. The base station 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted in one or more directions by a base station 105, a UE 115 may employ similar techniques for transmitting signals multiple times in different directions (e.g., for identifying a beam direction for subsequent transmission or reception by the UE 115) or for transmitting a signal in a single direction (e.g., for transmitting data to a receiving device).

A receiving device (e.g., a UE 115) may try multiple receive configurations (e.g., directional listening) when receiving various signals from the base station 105, such as synchronization signals, reference signals, beam selection signals, or other control signals. For example, a receiving device may try multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned in a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or Packet Data Convergence Protocol (PDCP) layer may be IP-based. A Radio Link Control (RLC) layer may perform packet segmentation and reassembly to communicate over logical channels. A Medium Access Control (MAC) layer may perform priority handling and multiplexing of logical channels into transport channels. The MAC layer may also use error detection techniques, error correction techniques, or both to support retransmissions at the MAC layer to improve link efficiency. In the control plane, the Radio Resource Control (RRC) protocol layer may provide establishment, configuration, and maintenance of an RRC connection between a UE 115 and a base station 105 or a core network 130 supporting radio bearers for user plane data. At the physical layer, transport channels may be mapped to physical channels.

The UEs 115 and the base stations 105 may support retransmissions of data to increase the likelihood that data is received successfully. Hybrid automatic repeat request (HARQ) feedback is one technique for increasing the likelihood that data is received correctly over a communication link 125. HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, where the device may provide HARQ feedback in a specific slot for data received in a previous symbol in the slot. In other cases, the device may provide HARQ feedback in a subsequent slot, or according to some other time interval.

In some examples, one or more devices in the wireless communications system 100, such as a UE 115, a base station 105, an IAB node, an remote unit (RU), a distributed unit (DU), a centralized unit (CU), or any combination thereof, may support OAM communications. A device that supports OAM communication may include a circular antenna array that includes multiple antenna subarrays, which may be referred to as a transmitter circle for a transmitting device or a receiver circle for a receiving device. Each antenna subarray may include one or more antenna elements. Techniques described herein provide for a transmitting device that includes a first quantity of antenna subarrays to support OAM communications with a receiving device that includes a second quantity of antenna subarrays different from the first quantity. In some examples, the first quantity of antenna subarrays may be an integer multiple of the second quantity of antenna subarrays, or vice versa. The transmitting device may generate one or more OAM signals for transmission to the receiving device via the transmitter circle. The transmitting device may transmit the one or more OAM signals (e.g., concurrently) to the second device using the transmitter circle and based on one or more sets of OAM weights. Each set of OAM weights may be referred to as an OAM weighting vector and may correspond to a respective OAM mode. The transmitting device may transmit each signal using a respective OAM mode and corresponding OAM weighting vector. The receiving device may receive and decode the OAM signals using the receiver circle and based on multiple OAM weighting vectors and corresponding OAM modes at the receiving device. In some examples, the OAM weighting vectors at the transmitting device, the OAM weighting vectors at the receiving device, or both may be based on the receiver circle and the transmitter circle having different quantities of antenna subarrays.

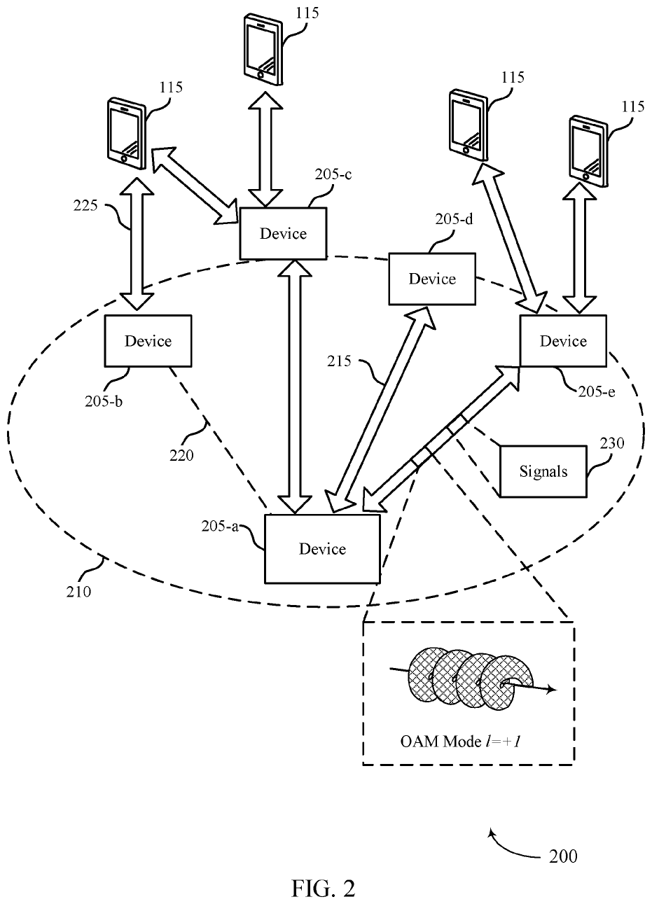

FIG. 2 illustrates an example of a wireless communications system 200 that supports OAM multiplexing using different quantities of transmit and receive antenna subarrays in accordance with aspects of the present disclosure. The wireless communications system 200 may implement or be implemented by aspects of the wireless communications system 100. The wireless communications system may include one or more devices 205 and UEs 115. The devices 205 may each be an example of a UE 115, a base station 105, an IAB node, a CU, a DU, an RU, or any other wired or wireless device. In some examples, the devices 205-a, 205-b, 205-c, 205-d, and 205-e may form a network device architecture 210, which may be used to relay signals from a radio access network (RAN) (e.g., using smart coordination) to the UEs 115 or other wireless access devices. The wireless communications system 200 (which may be an example of a sixth generation (6G) system, a fifth generation (5G) system, or another generation system) may support OAM-based communications and, as such, the devices 205 the one or more UEs 115, or both may transmit or receive OAM beams, or OAM-related signals over respective communication links.

The device 205-a may represent an example of a core unit of the network device architecture 210, such as a base station 105, a RAN CU, a RAN DU, or some other network node. In some cases, the device 205-a may be connected with the other devices 205 via wired fronthaul/backhaul communication links 220 (e.g., fiber-based fronthaul). Additionally or alternatively, the device 205-a may communicate with one or more other devices 205 of the network device architecture 210 via wireless fronthaul/backhaul communication links 215. The wireless fronthaul/backhaul communication links 215 may reduce cost and deployment complexity as compared with the wired fronthaul/backhaul communication links 220. The other devices 205 may represent examples of distributed network nodes, such as IAB nodes, repeaters, RUs, or any combination thereof that may relay signals from the RAN to one or more UEs 115 or other wireless devices via wireless access communication links 225.

The wireless communications system 200 may support various communications schemes, such as LoS-MIMO. In such environments, a direct link may be present between two or more devices 205 (e.g., without a physical obstruction). For example, the network device architecture 210 may occupy a relatively small area, such that a distance between the devices 205 is relatively short. The devices 205 may communicate according to one or more LoS-MIMO communication schemes using one or more antenna subarrays based on the relatively small distance between devices. Such LoS-MIMO communication schemes may support relatively high throughput and data capacities over relatively short distances. As such, LoS-MIMO may provide for the wireless fronthaul/backhaul communication links 215 to support sufficient data capacity between devices 205 of the network device architecture 210 without deploying physical fibers or cables. For example, the device 205-a (e.g., a DU or core network node) may be deployed with an aperture array that connects with one or more other devices 205 (e.g., instead of fibers). In some examples, the performance of the aperture array on the device 205-a may be optimized between the device 205-a and the other devices 205-c, 205-d, and 205-e to support relatively high throughput and capacity of the wireless fronthaul/backhaul communication links 215.

OAM-based communications may be an example of a LoS-MIMO communication scheme supported by the wireless communications system 200. Each of the devices 205, the UEs 115, or both may support OAM communication and may include an OAM antenna system having multiple antenna elements, antenna arrays, antenna subarrays, or any combination thereof arranged in one or more concentric circular arrays. The respective antenna arrays of the devices 205 may be installed or dynamically adjusted such that they are aligned along a first axis (e.g., a horizontal or vertical axis) as well as rotationally, or such that they are offset by a configured linear or rotational offset. OAM communication may support relatively high-order spatial multiplexing, and in some examples, the offsets between antenna subarrays may be configured to optimize orthogonality between signals and data throughput. OAM communication may support relatively high data rates between two or more devices 205 over relatively short distances. In some examples, the devices 205 may perform OAM communications in relatively high frequency spectrums (e.g., sub-THz, THz, etc.). Although OAM communication is described in the context of fronthaul and backhaul, it is to be understood that the communication techniques described herein may be applicable to any two wireless devices, include access devices (e.g., UEs, CPEs), network devices (e.g., base stations, DUs, CUs, RUs, IAB nodes), or both.

The devices 205 may support OAM-based communication by using OAM of electromagnetic waves to distinguish between different signals. For example, a transmitting device 205 may radiate multiple coaxially propagating, spatially-overlapping waves each carrying a data stream through an array of apertures. In some cases, the OAM of the electromagnetic wave may be associated with a field spatial distribution of the electromagnetic wave, which may be in the form of a helical or twisted wavefront shape. For example, an electromagnetic wave may correspond to a helical transverse phase of the form exp(iφl) may carry an OAM mode waveform, where φ may be an azimuthal angle of the waveform and l may be an unbounded integer, which may be referred to as an OAM order, a helical mode, or an OAM mode. Each OAM mode (e.g., OAM modes l= . . . , −2, −1, 0, 1, 2, . . . ) may be orthogonal.

Such OAM modes may be characterized by a wavefront that is shaped as a helix with an optical vortex in the center (e.g., at the beam axis), where each OAM mode is associated with a different helical wavefront structure. The OAM modes may be defined or referred to by the mode index l, where a sign of the mode index l corresponds to a “handedness” (e.g., left or right) of the helix (or helices) and a magnitude of the mode index l (e.g., |l|) corresponds to a quantity of distinct but interleaved helices of the electromagnetic wave.

For example, for an electromagnetic wave associated with an OAM mode index of l=0, the electromagnetic wave may not be helical and the wavefronts of the electromagnetic wave are multiple disconnected surfaces (e.g., the electromagnetic wave is a sequence of parallel planes). For an electromagnetic wave associated with an OAM mode index of l=+1, the electromagnetic wave may propagate in a right-handed pattern (e.g., has a right circular polarization or may be understood as having a clockwise circular polarization) and the wavefront of the electromagnetic wave may be shaped as a single helical surface with a step length equal to a wavelength λ of the electromagnetic wave. An example of such an electromagnetic wave is illustrated in FIG. 2. Similarly, for an OAM mode index of l=−1, the electromagnetic wave may propagate in a left-handed pattern (e.g., has a left circular polarization or may be understood as having a counter-clockwise circular polarization) and the wavefront of the electromagnetic wave may be also be shaped as a single helical surface with a step length equal to the wavelength λ of the electromagnetic wave.

For further example, for an OAM mode index of l=±2, the electromagnetic wave may propagate in either a right-handed pattern (if +2) or in a left-handed pattern (if −2) and the wavefront of the electromagnetic wave may include two distinct but interleaved helical surfaces. In such examples, the step length of each helical surface may be equal to λ/2. Likewise, the phase delay over one revolution of the electromagnetic wave may be equal to ±4π. In general terms, a mode-l electromagnetic wave may propagate in either a right-handed pattern or a left-handed pattern (depending on the sign of l) and may include l distinct but interleaved helical surfaces with a step length of each helical surface equal to λ/|l|. In some examples, an electromagnetic wave may be indefinitely extended to provide for an infinite number of degrees of freedom of the OAM of the electromagnetic wave (e.g., l=0, ±1, ±2, . . . , ±∞). As such, the OAM of the electromagnetic wave may be associated with infinite degrees of freedom.

In some examples, the OAM mode index l of an electromagnetic wave may correspond to or otherwise function as (e.g., be defined as) an additional dimension for signal or channel multiplexing. For example, each OAM mode, which may correspond to an OAM state (of which there may be infinite), may function similarly (e.g., or equivalently) to a communication channel, such as a sub-channel. In other words, an OAM mode or state may correspond to a communication channel, and vice versa. For instance, the devices 205 may communicate separate signals 230 using electromagnetic waves having different OAM modes or states similarly to how the devices may transmit separate signals over different communication channels. In some aspects, such use of the OAM modes or states of an electromagnetic wave to carry different signals 230 may be referred to as the use of OAM beams.

Such OAM waveforms associated with different OAM modes may be orthogonally received at a same time and frequency radio resource, which may improve communication spectrum efficiency with relatively low processing complexity at a receiving device 205. For example, a transmitting device 205, such as the device 205-a, may transmit one or more signals 230 to a receiving device 205, such as the device 205-e, using multiple OAM modes. Each signal 230 may be transmitted according to a respective OAM mode, such that the signals 230 do not overlap or interference with each other. In some examples, two or more signals may be transmitted concurrently. If polarizations are added to the OAM modes, a quantity of orthogonal OAM streams may increase.

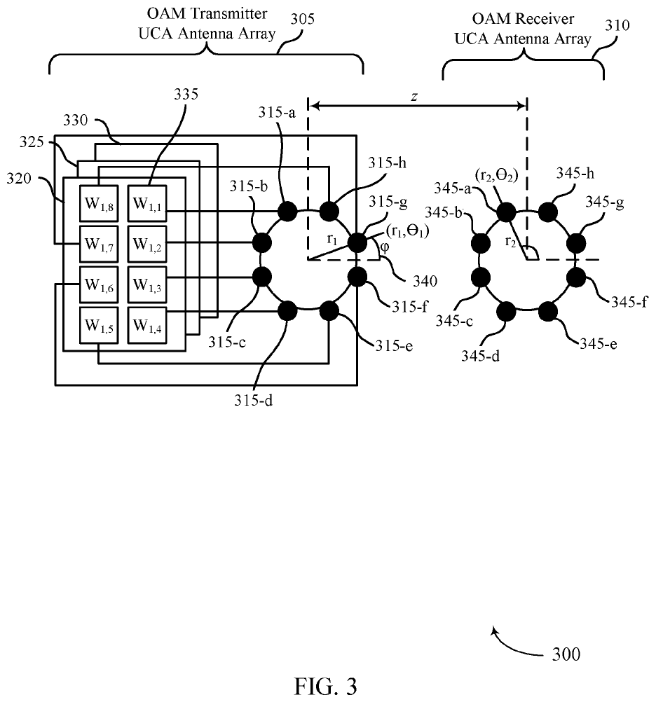

To support such OAM communication, each device 205 may be configured with a set of antenna subarrays configured in a circle, such as a uniform circular array (UCA) antenna circle (e.g., an antenna circle, a transmitter circle, or a receiver circle). Each device 205 may be equipped with one or more UCA circles that the device 205 may use to communicate according to one or more OAM modes. The OAM antenna array configurations are described in further detail elsewhere herein, including with reference to FIGS. 3-5.

In some cases, the transmitting device 205-a and the receiving device 205-e may be configured with a same quantity of antenna subarrays at each device 205. A quantity of OAM modes that can be generated by each device 205 may correspond to the quantity of antenna subarrays. For example, if a device 205 has N antenna subarrays, the device 205 may be configured to generate N OAM modes. Each OAM mode may correspond to a set of OAM weights (e.g., an OAM weighting vector) to be applied to the antenna subarrays of the transmitting device 205-a when generating the transmission. The receiving device 205-e may utilize the OAM modes corresponding to the quantity of antenna subarrays to identify weights applied by the transmitting device 205-a to the OAM signals. The receiving device 205-e may receive and decode the OAM signals based on the weights.

In some examples, however, a quantity of antenna subarrays at the transmitting device 205-a may be different than a quantity of antenna subarrays at the receiving device 205-e. For example, the devices 205 may be deployed with different quantities of antenna subarrays, or the devices 205 may be configured to dynamically activate or deactivate one or more antenna subarrays of the device 205 based on a set of communication parameters. The quantity of antenna subarrays at a device 205 (e.g., a quantity of configured antenna subarrays or a quantity of activated antenna subarrays) may be based on a condition of a channel between the device 205 and another device 205, a type of the device 205, power consumption of the device 205, a type of communication performed by the device 205, a size of the device 205, beamforming capabilities of the device 205, processing capabilities of the device 205, or any combination thereof. If the quantity of antenna subarrays of a transmitter circle is different than a quantity of antenna subarrays of a receiver circle, the receiving device 205-e, in some cases, may be unable to accurately receive and decode OAM transmissions from the transmitting device 205-a due to relatively complex processing associated with decoding such a channel.

As described herein, the devices 205 may be configured with methods for supporting OAM communications using a different quantity of transmitter antenna subarrays than receiver antenna subarrays. The devices 205 may exchange signaling to indicate the respective quantity of antenna subarrays. For example, the receiving device 205-e may transmit signaling to the transmitting device 205-a to indicate the quantity of receiver antenna subarrays and the transmitting device 205-a may transmit signaling to the receiving device 205-e, one or more other devices 205 (e.g., via a broadcast message), or both, to indicate the quantity of transmitter antenna subarrays. The signaling may be RRC signaling, a MAC-CE, a physical layer control channel, or any combination thereof configured to indicate the quantity of antenna subarrays. In some examples, the signaling may be transmitted semi-statically (e.g., an RRC configuration). Additionally or alternatively, the devices 205 may dynamically transmit the signaling to indicate changes in quantities of antenna subarrays over time.

The receiving device 205-e may use the indicated quantity of antenna subarrays to decode a channel between the transmitting device 205-a and the receiving device 205-e with relatively low complexity. Methods for configuring antenna arrays and decoding the channel are described in further detail elsewhere herein, including with reference to FIGS. 3-5.

FIG. 3 illustrates an example of an OAM antenna array configuration 300 that supports OAM multiplexing using different quantities of transmit and receive antenna subarrays in accordance with aspects of the present disclosure. In some examples, the OAM antenna array configuration 300 may implement aspects of wireless communications systems 100 or 200. In this example, a transmitting device (e.g., a UE, a base station, an RU, a DU, a CU, an IAB node or some other device) may include an OAM transmitter UCA antenna array 305 and a receiving device (e.g., a UE, a base station, an RU, a DU, a CU, an IAB node or some other device) may include OAM receiver UCA antenna array 310.

In some aspects, one or both of the OAM transmitter UCA antenna array 305 or the OAM receiver UCA antenna array 310 may be implemented as a planar array of antenna elements, or individual antenna arrays or antenna subarrays, which may be an example of or otherwise function as a (massive or holographic) MIMO array or an intelligent surface. In some cases, the transmitting device may identify a set of antenna subarrays 315 of the planar array that form a transmitter UCA (e.g., transmitter antenna subarrays 315-a, 315-b, 315-c, 315-d, 315-e, 315-f, 315-g, and 315-h), and a receiving device may identify a set of antenna subarrays 345 of the planar array that form a receiver UCA (e.g., receiver antenna subarrays 345-a, 345-b, 345-c, 345-d, 345-e, 345-f, 345-g, and 345-h).

Upon selecting the set of antenna subarrays from the planar array, the transmitting device may apply a weight 335 to each of the selected antenna subarrays 315 based on the OAM mode index l of the transmitted OAM beam and one or more spatial parameters associated with each antenna subarray 315. In cases in which a UCA methodology is used to generate an OAM beam, the transmitting device may identify the set of antenna subarrays 315 on a circular array of antenna elements and may apply a first set of weights 320 to each of the identified antenna subarrays 315 based on a first OAM mode index (e.g., l=0). Further, for other OAM mode indices, other weights may be used for the set of antenna subarrays 315, such as a second OAM mode index (e.g., l=+1) that may use a second set of weights 325 and a third OAM mode index (e.g., l=−1) that may use a third set of weights 330. Each OAM mode may be characterized by a different helical wave structure, as described with reference to FIG. 2. The helical wave structure for each mode may be generated by applying the respective set of weights to the antenna subarrays 315 of the transmitting device.

For example, to generate an OAM beam with an OAM mode index (e.g., l=0), the transmitting device may apply a weight 335 to each antenna subarray 315 on the UCA based on an angle 340 measured between a reference line on the UCA (e.g., the x-axis of the plane on which the UCA is located, where the origin is at the center of the UCA) and the antenna subarray 315, the OAM mode index l, and i (e.g., for complex-valued weights, which may alternatively be denoted as j in some cases). In some cases, for instance, the weight for an antenna element n may be proportional to e^{i*l*φ}^{ₙ}, where φₙ is equal to the angle 340 measured between the reference line on the UCA and the antenna element n. By multiplying respective beamforming weights 335 of each set of weights 320-330 (e.g., for first set of weights 320, w₁=[w_{1,1}, w_{1,2}, . . . , w_{1,8}]^{T}) onto each antenna subarray 315, a signal port may be generated. If the weight 335 of each antenna subarray 315 is equal to e^{iφl}, where φ is the angle of an antenna subarray 315 in the circle (e.g., angle 340 for antenna subarray 315-g), and l is the OAM mode index, then each set of weights 320-330 provides a beamformed port that is equivalent to OAM mode l. By using different beamforming weights e^{iφl′}, where l′≠l, multiple OAM modes are thus generated.

At the OAM receiver UCA antenna array 310, the receiving device may have receive antenna subarrays 345 equipped in a circle. The channel matrix may be denoted from each transmit antenna subarray 315 to each receive antenna subarray 345 as H, and then for the beamformed channel matrix \tilde{H}=H·[w₁, w₂, . . . , w_{L}]. Any two OAM weighting vectors of [w₁, w₂, . . . , w_{L}] may be orthogonal relative to each other. In some examples, for N transmit antenna subarrays 315 and N receive antenna subarrays 345, the transfer matrix H may be found via discreet angular sampling using Equation 1, shown below.

$$\begin{matrix}{H}_{m , n} ∝ \frac{exp ( jk \sqrt{{z}^{2} + {( {r}_{1} - {r}_{2} cos {θ}_{2} )}^{2} +} )}{\sqrt{{z}^{2} + {( {r}_{1} cos {θ}_{1} - {r}_{2} cos {θ}_{2} )}^{2} + {( {r}_{1} sin {θ}_{1} - {r}_{2} sin {θ}_{2} )}^{2}}} \\ = \frac{exp \{ jk \sqrt{{z}^{2} + {r}_{1}^{2} + {r}_{2}^{2} - 2 {r}_{1} {r}_{2} cos ( {θ}_{1} - {θ}_{2} )} \}}{\sqrt{{z}^{2} + {r}_{1}^{2} + {r}_{2}^{2} - 2 {r}_{1} {r}_{2} cos ( {θ}_{1} - {θ}_{2} )}}\end{matrix} \qquad ( 1 )$$

In the example of Equation 1, beamformed ports may not experience crosstalk because of orthogonality between columns of the transfer matrix H. This may enable OAM-based communication to realize high-level spatial multiplexing more efficiently. Further, the eigen-based transmit precoding weights and receive combining weights of UCA-based OAM procedures may be equal to a discrete Fourier transform (DFT) matrix. As the transfer matrix H is cyclic or circulant, eigenvectors of the transfer matrix H may be DFT vectors, as described in Equation 2.

$${v}_{u} = exp \{ j \frac{2 π μ v}{N} \} \qquad ( 2 )$$

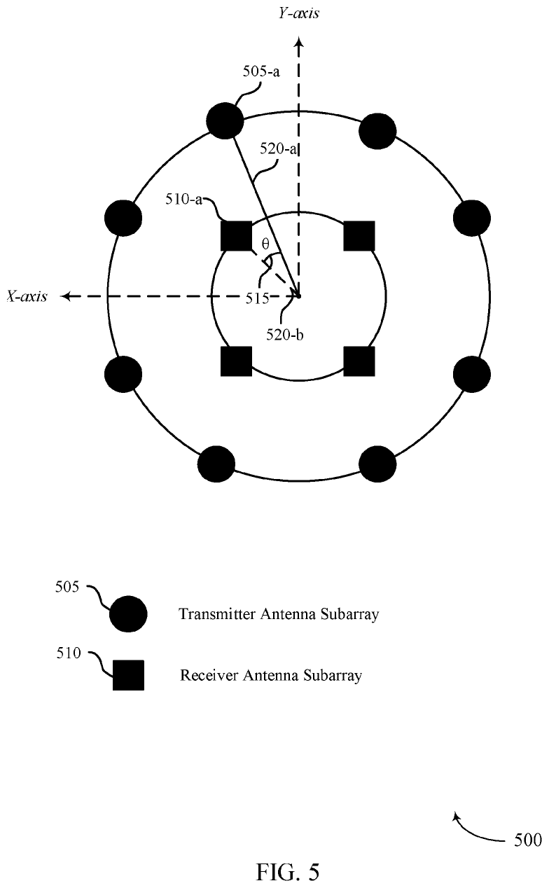

In the example of Equation 2, μ and v may be integers within a range (e.g., μ=0, 1, . . . (N−1), v=0, 1, . . . (N−1)), where μ is a vector index of a DFT vector and v is the element index in each DFT vector. With respect to each OAM mode, the μ-th DFT vector may correspond to the μ-th OAM waveform. In some cases, the eigen modes may be identified by performing a singular value decomposition (SVD) on a transfer matrix. In some cases, with N transmit antenna subarrays 315 and receive antenna subarrays 345, all OAM modes (e.g., 0, 1, . . . (N−1) OAM modes) may be orthogonal at the receiver if any of them are transmitted, regardless of distance z and radii of the transmitter and receiver circles. In some cases, it may be beneficial to have both transmitter and receiver planes be co-axial and vertical to the z-axis, although the transmitter and the receiver antenna subarrays may have angular offsets, or may be in other configurations, as described in further detail elsewhere herein, including with reference to FIG. 5.

In some examples, a quantity of transmit antenna subarrays 315 (N) may be different than a quantity of receive antenna subarrays 345 (M). The quantity of antenna subarrays on each device may be based on a condition of a channel between devices, a type of the device (e.g., an RU, a DU, a base station 105, a UE 115, or some other type of device), a size of the device, one or more capabilities of the device, power consumption of the device, or any combination thereof. If the transmitting device is a different type of device or has different capabilities or power restraints than the receiving device, the quantity of transmit antenna subarrays 315 may be different than a quantity of receive antenna subarrays 345 (e.g., M≠N). In such cases, the transfer matrix H may not be circulant. If a maximum of the quantity of transmit or receive antenna subarrays (e.g., max(M, N)) is not a multiple of a minimum of the quantity of transmit and receive antenna subarrays (e.g., min(M, N)), the circulant property may not hold, such that a DFT vector may not be a left singular or right singular vector of the transfer matrix H. In such cases, calculating the eigenvectors of the transfer matrix may be relatively complex and a simplifying structure for an SVD of the transfer matrix may not be defined.

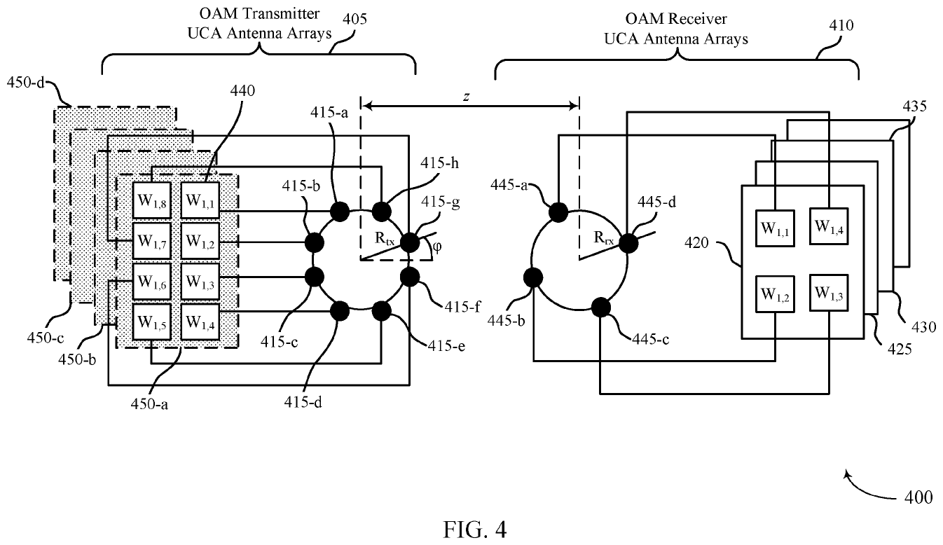

A method for performing an SVD of the transfer matrix when a quantity of transmit antenna subarrays 315 on the transmitting device is different than a quantity of receive antenna subarrays 345 on the receiving device is described. The quantity of transmit antenna subarrays 315 may be an integer multiple of or evenly divisible by the quantity of receive antenna subarrays 345, or vice versa, to simplify the SVD (e.g., M=KN or N=KM, where K is an integer factor that is greater than zero). Techniques for configuring such antenna subarrays and performing the SVD are described in further detail elsewhere herein, including with reference to FIGS. 4 and 5.

It is to be understood that antenna arrays including multiple antenna subarrays described herein may alternatively be referred to as transmitter circles or receiver circles. Further, the same circular antenna array may at times act as a transmitter circle and may at times act as a receiver circle, but may be referred to as one or the other for the sake of clarity in related descriptions. It is to be understood that any signaling described as received by a device having a transmitter circle could be received via the transmitter circle or via another antenna array, antenna subarray, or antenna element at the device (e.g., a separate receiver circle at the device or some other antenna array or element at the device). Similarly, any signaling described as transmitted by a device having a receiver circle could be transmitted via the receiver circle or via another antenna array, antenna subarray, or antenna element at the device (e.g., a separate transmitter circle at the device or some other antenna array or element at the device). Additionally, though referred to herein as transmit antenna subarrays 315 and receive antenna subarrays 345, it is to be understood that these aspects may alternatively be referred to as transmit antenna arrays and receive antenna arrays, each of which may include multiple antenna elements.

FIG. 4 illustrates an example of an OAM antenna array configuration 400 that supports OAM multiplexing using different quantities of transmit and receive antenna subarrays in accordance with aspects of the present disclosure. In some examples, the OAM antenna array configuration 400 may implement or be implemented by aspects of wireless communications systems 100 or 200 or the OAM antenna array configuration 300. In this example, a transmitting device (e.g., a UE, a base station, an RU, a DU, a CU, an IAB node or some other device) may include an OAM transmitter UCA antenna array 405 and a receiving device (e.g., a UE, a base station, an RU, a DU, a CU, an IAB node or some other device) may include an OAM receiver UCA antenna array 410.

In some aspects, the transmitting device may identify a set of antenna subarrays 415 of the planar array that form a transmitter UCA (e.g., transmitter antenna subarrays 415-a, 415-b, 415-c, 415-d, 415-e, 415-f, 415-g, and 415-h), and a receiving device may identify a set of antenna subarrays 445 of the planar array that form a receiver UCA (e.g., receiver antenna subarrays 445-a, 445-b, 445-c, and 445-d). A quantity of antenna subarrays 415 and 445 in each UCA may be based on a condition of a channel between the devices, a type of the device, a size of the device one or more capabilities of the device, power consumption of the device, or any combination thereof, as described with reference to FIG. 3.

In some cases, upon selecting the set of antenna elements from the planar array, the transmitting device may apply a weight 440 to each of the selected antenna subarrays 415 based on an OAM mode index l of the transmitted OAM beam and one or more spatial parameters associated with each antenna subarray. As described with reference to FIG. 3, the receiving device may have receive antenna subarrays 445 equipped in a circle, and the receiving device may perform discrete angular sampling to identify a transfer matrix, H, for a beamformed channel between the devices using Equation 1. If the quantity of transmitter antenna subarrays 415 and the quantity of receiver antenna subarrays 445 is the same, the receiving device may identify the transfer matrix and use Equation 2 to determine the eigenvalues of the transfer matrix, which may be DFT vectors. The receiving device may use the DFT vectors to determine the weights applied to the signal and decode the signals received from the transmitting device.

In the example of FIG. 4, however, the OAM transmitter UCA antenna array 405 of the transmitting device may include a first quantity (N) of transmit antenna subarrays 415, that may be different than a second quantity (M) of receive antenna subarrays 445 of the OAM receiver UCA antenna array 410 of the receiving device. A quantity of OAM modes that a device may use to generate orthogonally isolated signals may be based on or the same as a quantity of antenna subarrays of the device, and each OAM mode may correspond to a DFT vector of a same quantity of OAM weights to apply to the antenna subarrays, as discussed with reference to Equation 2. As such, a first quantity of DFT vectors and corresponding OAM modes for the transmitting device may be the same as the quantity of transmitter antenna subarrays 415 (e.g., modes 0, 1, . . . N−1, where each mode corresponds to a respective OAM vector, or set of OAM weights), and a second quantity of DFT vectors and corresponding OAM modes for the receiving device may be the same as the quantity of receiver antenna subarrays 445 (e.g., a quantity of M M-ary DFT vectors each including a set of OAM weights).

In such cases, to determine the applied weights and decode the signals accurately, the receiving device may solve the entire channel matrix, which may be relatively complex and may provide for relatively high processing latency and power consumption. For example, the circulant property may not hold for the transfer matrix H, such that a DFT vector may not be a left singular or right singular vector of the transfer matrix H. As such, performing an SVD of the transfer matrix to determine the applied weights may be relatively complex.

Techniques for performing OAM beamforming with reduced complexity between a transmitting device and a receiving device having different quantities of antenna subarrays are described herein. The described techniques may provide a simplifying structure for an SVD, such that the receiving device may identify eigenvalues of the transfer matrix to decode signals accurately with reduced complexity (e.g., the eigenvalues may be DFT vectors). To simplify the SVD, the quantity of transmitter antenna subarrays 415 may be an integer multiple of or evenly divisible by the quantity of receiver antenna subarrays 445, or vice versa. For example, N=KM or M=KN, where N represents the quantity of transmitter antenna subarrays 415, M represents the quantity of receiver antenna subarrays 445, and K is an integer factor that is greater than zero. In the example of FIG. 4, the OAM transmitter UCA antenna array 405 may include eight transmit antenna subarrays 415, the OAM receiver UCA antenna array 410 may include four receive antenna subarrays 445, and the integer factor may be two. Although FIG. 4 illustrates more transmit antenna subarrays 415 than receive antenna subarrays 445, it is to be understood that the transmitting and receiving devices may include any quantity of antenna subarrays. For example, in some cases, there may be more receive antenna subarrays 445 at the receiving device than transmit antenna subarrays 415 at the transmitting device.

Configuring the quantities of transmit antenna subarrays 415 and receive antenna subarrays 445 to be integer multiples may provide for a simplification of an SVD of the transfer matrix, as described herein. The M by N channel response matrix assuming N=KM, H, may be defined according to Equation 3.

$$H = [ \begin{matrix}{h}_{0} & {h}_{1} & … & {h}_{N - 1} \\ {h}_{M} & {h}_{M + 1} & … & {h}_{M - 1} \\ … & … & … & … \\ {h}_{( K - 1 ) M} & {h}_{( K - 1 ) M + 1} & … & {h}_{N - M - 1}\end{matrix} ] \qquad ( 3 )$$

In the example of Equation 3, each row of the channel response matrix, H, may be a cyclic shift by M of the row above it. Each column may be a cyclic shift of the full h-vector and then down-sampled by a factor of M. The circulant property of H may imply that h_{m,n} can be represented by h_{m(K-1)+n}, where hₙ is the n^{th} element of the channel response vector of length N with cyclic shift if n≥N. The properties of the channel response matrix may be based on N being an integer multiple of M by the integer factor K. The SVD of the channel response matrix may be H=UΛV^{H}, where U may be an M-DFT matrix, and uₘ may be the m-th DFT vector (e.g., U=[u₀, u₁, . . . , u_{M-1}]). Λ and V are defined according to Equations 4 and 5, respectively.

$$Λ = [ \begin{matrix}\sqrt{K {\sum }_{k = 0}^{K - 1} {\vert {σ}_{kM} \vert}^{2}} & 0 & … & 0 & 0 \\ 0 & \sqrt{K {\sum }_{k = 0}^{K - 1} {\vert {σ}_{kM + 1} \vert}^{2}} & … & 0 & 0 \\ … & … & … & … & … \\ 0 & 0 & \sqrt{K {\sum }_{k = 0}^{K - 1} {\vert {σ}_{kM + ( M - 1 )} \vert}^{2}} & 0 & 0\end{matrix} ] \qquad ( 4 )$$

$$V = [ \frac{{\sum }_{k = 0}^{K - 1} {σ}_{kM}^{*} {v}_{kM}}{\sqrt{K {\sum }_{k = 0}^{K - 1} {\vert {σ}_{kM} \vert}^{2}}} , \frac{{\sum }_{k = 0}^{K - 1} {σ}_{kM + 1}^{*} {v}_{kM + 1}}{\sqrt{K {\sum }_{k = 0}^{K - 1} {\vert {σ}_{kM + 1} \vert}^{2}}} , \frac{{\sum }_{k = 0}^{K - 1} {σ}_{kM + ( M - 1 )}^{*} {v}_{kM + ( M - 1 )}}{\sqrt{K {\sum }_{k = 0}^{K - 1} {\vert {σ}_{kM + ( M - 1 )} \vert}^{2}}} , … , ] \qquad ( 5 )$$

In the example of Equation 5, vₙ is the n^{th} DFT vector. As described herein, if there are more transmitter antenna subarrays 415 than receiver subarrays 445 (e.g., N=KM), the receiving device may perform receive beamforming based on a same quantity of DFT vectors as the quantity of receiver antenna subarrays 445 (e.g., M-DFT vectors), as described with reference to FIG. 3. The transmitting device (e.g., the device with more antenna subarrays) may determine a different quantity, N, of DFT vectors. To provide for a same quantity of OAM transmit and receive modes, the transmitting device described herein may be configured to divide the N OAM modes (e.g., modes 0, 1, 2, . . . (KM−1)) into M OAM mode groups 450 (e.g., M modulo-mode-sets indexed by mod(N, M)). Each OAM mode group 450 may include a same quantity of OAM modes as the integer factor (e.g., K members in each OAM group 450). The OAM modes in each OAM mode group 450 may be aliases of each other, and each OAM mode group 450 may be orthogonal. In the example of FIG. 4, the transmitting device may group OAM modes of a DFT vector including eight elements into four OAM groups 450-a, 450-b, 450-c, and 450-d, each including two OAM modes.

The transmitting device may apply a weighted average to the OAM modes in each OAM group 450. As such, sets of OAM weights for each respective OAM mode may be averaged before generating a transmission. The weighted average may be based on a channel estimation procedure and a channel response vector, as described with reference to Equations 6 and 7 below. The transmitting device may thereby identify a same quantity of OAM mode groups 450 as the quantity of OAM modes at the receiving device without solving the channel matrix. For example, there may be four OAM mode groups 450 and four OAM modes at the receiving device (e.g., corresponding to each of the sets of OAM weights 420, 425, 430, and 435). The transmitting device may select an OAM mode and corresponding OAM vector including a set of averaged OAM weights from the OAM mode groups 450, which may provide for the devices to perform OAM beamforming using the selected OAM modes with improved reliability and reduced complexity.

The transmitting device may determine a weighting factor for combining OAM modes in each OAM mode group 450 (e.g., for coherent combining) based on a channel estimation procedure. To perform the combining, the transmitting device may multiply the determined weighting factors by each OAM vector (e.g., each DFT vector including a respective set of OAM weights) corresponding to each OAM mode in the OAM mode group 450 to obtain a set of averaged OAM weights 440 to use for communication. The channel estimation procedure may be a reference signal aided channel estimation procedure performed by the transmitting device, the receiving device, or both. The channel estimation may be performed regardless of whether the antenna subarray quantities are the same or different. As such, the channel estimation procedure may not provide for increased overhead or latency.

The channel estimation procedure may include estimating a strength of the channel based on a pilot signal. The weighting factors may be determined based on the estimated strength of the channel. In some examples, the device with fewer antenna subarrays may transmit the reference signals. In the example of FIG. 4, the receiving device may transmit the reference signals to the transmitting device based on the receiving device having fewer antenna subarrays. The receiving device may choose one or more receiver antenna subarrays 445 for the channel estimation. The receiving device may transmit the reference signals from the selected one or more antenna subarrays 445. If the receiving device transmits the reference signal from more than one antenna subarray 445, each antenna subarray 445 and corresponding reference signal may be distinguishable based on code division multiplexing (CDM) or cyclic shifts applied to the reference signals. The transmitting device may estimate multiple sets of channel gains for each selected receive antenna subarray 445. That is, for each receive antenna subarray 445, the transmitting device may estimate a set of channel gains including a respective channel gain between the receiver antenna subarray 445 and each transmitting antenna subarray 415. The full channel estimation may be characterized based on the estimation. For example, the estimation may be averaged for multiple receiver antennas. It is to be understood that, in some examples, the transmitting device may include fewer antenna subarrays than the receiving device, and, in such examples, the transmitting device may transmit the reference signals and the receiving device may perform the channel estimation according to the described techniques.

In some other examples, the device with more antenna subarrays may transmit reference signals to the other device. In the example of FIG. 4, the transmitting device may transmit reference signals to the receiving device from each transmitter antenna subarray 415 of the transmitter circle based on the transmitting device having more antenna subarrays. Each reference signal and corresponding transmitter antenna subarray 415 may be distinguishable from each other based on CDM or cyclic shifts applied to the reference signals. The receiving device may select one or more receiver antenna subarrays 445 for the channel estimation. The receiving device may estimate a channel gain between the selected one or more receiver antenna subarrays 445 and all of the transmitter antenna subarrays 415. The devices may characterize the full channel matrix based on the estimation by the receiving device. For example, the estimation may be averaged with multiple receiving antennas. It is to be understood that, in some examples, the receiving device may include more antenna subarrays than the transmitting device, and, in such examples, the receiving device may transmit the reference signals and the transmitting device may perform the channel estimation according to the described techniques.

In some examples, both the receiving device and the transmitting device may transmit reference signals and perform a channel estimation. In such cases, the channel response vector may be based on both channel gain estimations. Regardless of which device performs the channel estimation, the channel matrix may be characterized and a channel response vector may be determined based on the channel estimation procedure. The weighting factors may be determined based on a function of the channel response vector for the single OAM mode. The channel response vector may be represented by Equation 6.

$${σ}_{n} = {\sum }_{s = 0}^{N - 1} {h}_{s} exp \frac{- j 2 π n s}{N} \qquad ( 6 )$$

Due to the circulant property of the full channel matrix (e.g., as described with reference to Equation 3), the weights may be obtained by taking the DFT of the channel response vector in Equation 6. In such cases, the optimal weighting factors may be the m^{th} element of V as defined in Equation 5, where m may represent an index of the OAM mode group 450. For example, the optimal weighting factors may be defined according to Equation 7.

$$\frac{{\sum }_{k = 0}^{K - 1} {σ}_{kM + m}^{*} {v}_{kM + m}}{\sqrt{K {\sum }_{k = 0}^{K - 1} {\vert {σ}_{kM + m} \vert}^{2}}} \qquad ( 7 )$$

The transmitting device may apply the optimal weighting factor to each OAM vector in each OAM mode group 450 to obtain a set of averaged OAM weights 440. The transmitting device may simultaneously use the multiple modes in the same OAM mode group 450 to transmit a same signal to the receiving device by applying the determined weighting factor. The OAM modes in different OAM mode groups 450 may be orthogonal, such that the transmitting device may still support orthogonal OAM communications. By grouping OAM modes at the transmitter side, the transmitting device may select an OAM mode from a same quantity of OAM mode groups 450 as a quantity of OAM modes at the receiver side (e.g., M OAM mode groups and M OAM modes at the receiver side, where M=4 in the example of FIG. 4). Additionally or alternatively, in some examples, the transmitting device may refrain from performing the weighted average and the transmitting device may select a single OAM mode from each OAM mode group 450 based on communication parameters, such as channel quality or other communication parameters.

Although FIG. 4 illustrates more transmitter antenna subarrays 415 than receiver antenna subarrays 445, it is to be understood that either device may have more antenna subarrays than the other. For example, in some cases there may be more receiver antenna subarrays 445 than transmitter antenna subarrays 415, and the described methods and properties may still apply. In such cases, the receiving device may group OAM modes and corresponding sets of OAM weights into OAM mode groups 450 and perform a weighted average to combine the OAM modes in each OAM mode group 450. The receiving device may utilize the combined OAM mode groups 450 to receive and decode OAM signals from the transmitting device.

In the example of FIG. 4, the transmitter antenna subarrays 415 may be aligned with the receiver antenna subarrays 445. That is, the antenna subarrays on each device may be installed or dynamically adjusted or activated such that they are aligned along a first axis (e.g., a horizontal or vertical axis) as well as rotationally (e.g., the transmitter antenna subarrays 415 may be aligned with the receiver antenna subarrays 445 in various rotational axes). However, it is to be understood that any linear or angular offset may be applied between antenna subarrays. For example, OAM communication may support relatively high-order spatial multiplexing, and in some examples, angular offsets between antenna subarrays may be configured to optimize orthogonality between signals and improve data throughput. Configurations of angular offsets between subarrays may be described in more detail elsewhere herein, including with reference to FIG. 5.

FIG. 5 illustrates an example of an OAM antenna array configuration 500 that supports OAM multiplexing using different quantities of transmit and receive antenna subarrays in accordance with aspects of the present disclosure. The OAM antenna array configuration 500 may implement or be implemented by aspects of the wireless communications system 200 or the OAM antenna array configurations 300 and 400. For example, the OAM antenna array configuration 500 illustrates a configuration of antenna subarrays at a transmitting device and a receiving device. The transmitting and receiving devices may represent examples of corresponding devices as described with reference to FIGS. 2-4 (e.g., a UE, a base station, a CU, a DU, an RU, an IAB node, or any other device).

In this example, the transmitting device may include a first circular antenna array that includes a first quantity of transmitter antenna subarrays 505 and the receiving device may include a second circular antenna array that includes a second quantity of receiver antenna subarrays 510. The first circular antenna array and the second circular antenna array may be referred to as a transmitter circle and a receiver circle, respectively. The first quantity of transmitter antenna subarrays 505 (e.g., eight) of the transmitter circle may each be located at a respective first angular offset relative to a first axis that bisects the transmitter circle (e.g., the y-axis in FIG. 5). The second quantity of receiver antenna subarrays 510 (e.g., four) of the receiver circle may each be located at a respective second angular offset relative to a second axis that bisects the receiver circle (e.g., the y-axis in FIG. 5). Each respective first angular offset may be different from each respective second angular offset. Although the transmitter circle and the receiver circle are overlapping in FIG. 5 for clarity purposes, it is to be understood that the transmitter and receiver circles (e.g., and the corresponding devices) may be located any distance from one another, as described with reference to FIGS. 2-4.

The quantity of transmitter antenna subarrays 505 may be an integer multiple of or evenly divisible by the quantity of receiver antenna subarrays 510, or vice versa, to provide for simplified OAM beamforming techniques, as described with reference to FIG. 4. In the example of FIG. 5, the transmitting device may include eight transmitter antenna subarrays 505 and the receiving device may include four receiver antenna subarrays 510. Although more transmitter antenna subarrays 505 than receiver antenna subarrays 510 are illustrated in FIG. 5, it is to be understood that the transmitting and receiving devices may include any quantity of antenna subarrays. In some examples, there may be more receiver antenna subarrays 510 than the transmitter antenna subarrays 505.

In some cases (not illustrated in FIG. 5), the transmitter circle at the transmitting device and the receiver circle at the receiver device may be angularly aligned. For example, there may not be an offset between a first antenna subarray of the transmitter circle and a first antenna subarray of the receiver circle. In such cases, aliasing may occur, which may reduce data throughput and a reliability of communications. Aliasing may correspond to an underrepresentation of a system when the system is represented by finite samples. For example, sampling a continuous signal may create interference or may permit at least some misrepresentation of the continuous signal, which may be referred to as aliasing.

In the example of OAM communications, the receiver and transmitter circles may be quantized or digitized to include a finite quantity of antenna subarrays, which may represent the finite samples. For example, the receiving device may sample one or more signals received from the transmitting device at each antenna subarray, where the antenna subarrays disposed in a circle may represent finite samples of the continuous circle. In the example of FIG. 5, the signal transmitted by the transmitting device may be sampled eight times (e.g., at each transmitter antenna subarray 505), and the signal may be sampled at the receiving device four times (e.g., at each receiver antenna subarray 510).

The receiving device may experience fluctuations or oscillations in the OAM modes used for communications due to interference captured by the finite antenna subarrays (e.g., the antenna subarrays may capture additional signaling or interference different than the intended OAM mode or may not capture signaling that is part of the intended OAM mode). In some examples, a higher-order OAM mode (e.g., an OAM mode with an index greater than eight) may be interfere with a lower-order OAM mode supported by the devices. The receiving device may not be able to distinguish the correct OAM mode from the interfering signals corresponding to other OAM modes. That is, because of the finite samples, the receiver may be unable to differentiate signals generated in accordance with OAM modes corresponding to a faster oscillation from signals generated in according with OAM modes corresponding to a slower oscillation.

The effects of aliasing for a transmitter and receiver circle pair each having a same quantity of antenna subarrays, N, that are not offset by an angular offset may be described with respect to Equations 8 through 10. For example, the mode response of each transmitter and receiver circle pair, as described according to Equation 2, may be further analyzed according to Equation 8, which utilizes Taylor expansion approximations.

$$( 8 )$$

$$\begin{matrix}\sqrt{{z}^{2} + {r}_{1}^{2} + {r}_{2}^{2} - 2 {r}_{1} {r}_{2} cos ( {θ}_{1} - {θ}_{2} )} = z \sqrt{1 + \frac{{r}_{1}^{2} + {r}_{2}^{2} - 2 {r}_{1} {r}_{2} cos ( {θ}_{1} - {θ}_{2} )}{{z}^{2}}} \\ \approx z ( 1 + \frac{{r}_{1}^{2} + {r}_{2}^{2} - 2 {r}_{1} {r}_{2} cos ( {θ}_{1} - {θ}_{2} )}{2 {z}^{2}} ) \\ = + \frac{{r}_{1}^{2} + {r}_{2}^{2}}{2 z} - \frac{{r}_{1} {r}_{2} cos ( {θ}_{1} - {θ}_{2} )}{z}\end{matrix}$$

Equation 8 may then be incorporated into Equation 1, yielding Equation 9 as shown below.

$$( 9 )$$

$${H}_{m , n} ∝ \frac{exp \{ jk \sqrt{{z}^{2} + {r}_{1}^{2} + {r}_{2}^{2} - 2 {r}_{1} {r}_{2} cos ( {θ}_{1} - {θ}_{2} )} \}}{\sqrt{{z}^{2} + {r}_{1}^{2} + {r}_{2}^{2} - 2 {r}_{1} {r}_{2} cos ( {θ}_{1} - {θ}_{2} )}} \approx \frac{exp \{ jk ( z + \frac{{r}_{1}^{2} + {r}_{2}^{2}}{2 z} ) \}}{z} exp \{ \frac{- {jkr}_{1} {r}_{2} cos ( {θ}_{1} - {θ}_{2} )}{z} \}$$

Assuming a continuous transmitter circle at the transmitting device, if a phase of e^{jlθ}^{₁} is applied by the transmitting device, a total received signal at a receive location of θ₂ on the receiver circle may be represented by Equation 10.

$${\int }_{0}^{2 π} exp \{ - jB cos ( {θ}_{1} - {θ}_{2} ) \} exp ( jl {θ}_{1} ) d {θ}_{1} = {( - j )}^{l} 2 {π J}_{l} ( B ) exp ( jl {θ}_{2} ) \qquad ( 10 )$$

In the example of Equation 10, B may be represented by

$$B = 2 π \frac{{r}_{1} {r}_{2}}{λ z} .$$

However, with discrete sampling by the transmitter antenna subarrays 505 (e.g., discrete transmitter antenna subarrays 505 located at

$${θ}_{1} = \frac{2 π p}{N} ,$$

with p=0, 1, . . . (N−1)), aliasing may exist. Aliasing may be present when the mode index, l, has a periodicity of N. For example, the received signal at a receive location of θ₂ on the receiver circle when discrete sampling is applied may be represented by Equation 11.

$$( 11 )$$

$$\frac{1}{\sqrt{N}} {\sum }_{p = 0}^{N - 1} exp \{ j \frac{2 π pl}{N} \} exp \{ - j 2 π \frac{{r}_{1} {r}_{2}}{λ z} cos ( \frac{2 π p}{N} - {θ}_{2} ) \} ∼ {\sum }_{v = - ∞}^{∞} {J}_{l + vN} ( B ) {( - j )}^{( l + v N )} {e}^{j ( l + v N ) {θ}_{2}} = {\sum }_{v = - ∞}^{∞} {J}_{l + vN} ( B ) {e}^{j ( l + v N ) ( - \frac{π}{2} + {θ}_{2} )}$$

Aliasing may thereby be present when discrete sampling is performed by the transmitting device, as evidenced by the differences between Equations 10 and 11. Similar aliasing effects may be experienced when a quantity of receiver antenna subarrays is different than a quantity of transmitter antenna subarrays and there is not an angular offset between antenna subarrays 510 of the receiver circle and antenna subarrays 505 of the transmitter circle.

As described herein, the antenna subarrays 505 of the transmitter circle may be offset from the antenna subarrays 510 in the receiver circle by a nonzero angular offset 515 to reduce effects of aliasing. The angular offset 515 may be a negative or positive rotational angle between a first transmitter antenna subarray 505-a of the transmitter circle and a first receiver antenna subarray 510-a of the receiver circle. The respective first antenna subarrays 505-a and 510-a may be defined arbitrarily or based on a location of an axis or other reference in the panel, such as an x-axis or y-axis through the circular plane, with an origin at the center of the transmitter and receiver circles.

A reference line at the transmitting device may be defined as the line 520-a from the center of the panel to the first transmitter antenna subarray 505-a. A reference line at the receiving device may be defined as the line 520-b from the center of the panel to the first receiver antenna subarray 510-a. The transmitter and receiver angular offset 515 may be define as the rotational angle, θ, between the reference lines 520-a and 520-b for the transmitting and receiving devices, respectively.

The angular offset 515 may be configured as a positive or negative nonzero value to reduce effects of aliasing as described herein. The value of the angular offset may be based on an analysis of the received signal when the quantity of transmitter antenna subarrays 505 is an integer multiple of the quantity of receiver antenna subarrays, or vice versa (e.g., N=KM or M=KN). In such cases, the received signal at the m^{th} receiver antenna subarray 510 of an subarray of M receiver antenna subarrays 510, where the m^{th} receiver antenna subarray 510 is at an angle of

$${θ}_{2} = \frac{2 π m}{M} + {θ}_{0} ,$$

is defined according to Equation 12.

$$Er ( {φ}_{m} ) = {J}_{l} ( B ) {( - j )}^{l} {e}^{jl ( \frac{2 π m}{M} + {θ}_{0} )} + {\sum }_{{v \neq 0}^{v = - ∞ ,}}^{∞} {J}_{l + vN} ( B ) {( - j )}^{( l + v N )} {e}^{j ( l + v N ) ( \frac{2 π m}{M} + {θ}_{0} )} \qquad ( 12 )$$

When the receiving device uses M discrete receiver antenna subarrays 510 to perform receiver beamforming, the received signal may be defined according to Equation 13.

$$( 13 )$$

$${\sum }_{m = 0}^{M - 1} Er ( {φ}_{m} ) exp [ - jl ( \frac{2 π m}{M} + {θ}_{0} ) ] = {MJ}_{l} ( B ) {( - j )}^{l} + {\sum }_{m = 0}^{M - 1} {{\sum }_{v = - ∞}^{∞}}_{v \neq 0} , \text{} {J}_{l + vN} ( B ) {( - j )}^{( l + v N )} {e}^{jvN ( \frac{2 π m}{M} + {θ}_{0} )} = {MJ}_{l} ( B ) {( - j )}^{l} + {{\sum }_{v}^{∞} = - ∞}_{v \neq 0} , {J}_{l + vN} ( B ) {( - j )}^{( l + v N )} {e}^{j ( l + v N ) {θ}_{0}} {\sum }_{m = 0}^{M - 1} {e}^{jvN \frac{2 π m}{M}}$$

When there are more transmitter antenna subarrays 505 than receiver antenna subarrays 510, there may be a single OAM mode in receiver processing. Orthogonality between OAM modes l′ and l′ may be present when |l−l′|≠M and orthogonality may be lost when |l−l′|=M. As such, modes in an OAM mode group 450 as described with reference to FIG. 4 may not be orthogonal. The aliasing may thereby be a result of the quantity of transmitter antenna subarrays 505, N, and may be relieved with a multiple of N, such that multiple OAM modes in an OAM mode group 450 may not impact the aliasing and corresponding choice of an angular offset. When there are more transmitter antenna subarrays 505, the aliasing terms with a non-zero index ν that satisfy

$$\frac{vN}{M}$$

being an integer remain. For example, the smallest vₘᵢₙ may be one.

When there are more receiver antenna subarrays 510 than transmitter antenna subarrays 505, orthogonality may similarly be lost when |l−l′|=M. However, this may not impact orthogonality because M is greater than N. In such cases, the aliasing terms with a non-zero index ν that satisfy

$$\frac{v N}{M}$$

being an integer remain. For example, the smallest vₘᵢₙ that satisfies vₘᵢₙN=max(M, N) may be the integer factor between quantities of antenna subarrays (e.g., vₘᵢₙ=K). This solution remains when multiple OAM modes are used to process a received signal for a single transmitter OAM mode. The formula using greatest common denominator may also be applicable for scenarios in which there are more transmitter antenna subarrays 505 than receiver antenna subarrays 510.

When there are a different quantity of transmitter antenna subarrays 505 than receiver antenna subarrays 510 (e.g., M≠N), the first non-zero aliasing term may be indexed by

$${v}_{min} = \frac{M}{min ( M , N )} ,$$

and the angular offset may be determined such that Equation 14 is satisfied.

$${e}^{{jv}_{min} N {θ}_{0}} = - {e}^{- j {v}_{min} N {θ}_{0}} ⇒ {e}^{j ( 2 {v}_{min} N {θ}_{0} )} = - 1 \qquad ( 14 )$$

To satisfy Equation 14, θ₀ may be determined according to Equation 15.

$${θ}_{0} = \frac{\pm ( 2 n + 1 ) π}{2 {v}_{min} N} \qquad ( 15 )$$

However, Equation 15 may not be true for all values of ν (e.g., v=1, 2, 3, . . . ). As such, one choice for θ₀ is

$${θ}_{0} = \pm \frac{π}{2 {Nv}_{min}} .$$

This may provide for a same angular offset 515 value for downlink and uplink scenarios (e.g., N transmitter antenna subarrays and M receiver antenna subarrays, or vice versa). If νₘᵢₙ is relatively large, the angular offset 515 may be zero or a very small value. aliasing may occur for high modes if νₘᵢₙ is relatively large, such that the aliasing may be suppressed naturally (e.g., without an angular offset 515).

Accordingly, an angular offset 515 may be determined to reduce aliasing effects during OAM communications. The angular offset 515 may be based on a quantity of transmitter antenna subarrays 505 and a quantity of receiver antenna subarrays 510. The angular offset 515 may be the same for different OAM modes. The transmitting and receiving devices may dynamically adjust the angular offset 515 if a quantity of antenna subarrays on one or both of the transmitter circle or the receiver circle changes. As described with reference to FIG. 2, the quantity of antenna subarrays on a device may change based on one or more parameters, and the devices may transmit signaling (e.g., RRC signaling, a MAC-CE or a physical layer control channel) to one another to indicate the quantity of antenna subarrays at the respective device. In some examples, the devices may adjust the angular offset 515 by moving antenna subarrays or by activating or deactivating one or more antenna subarrays.

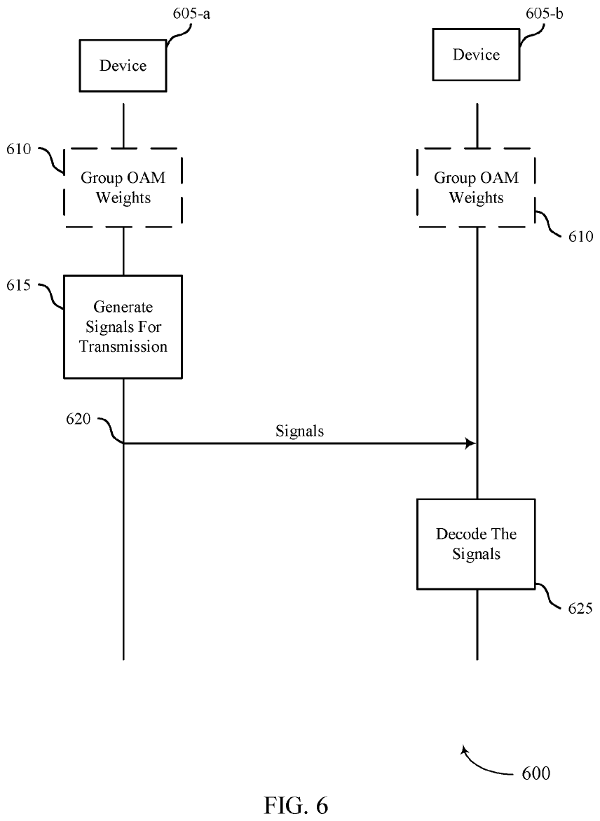

FIG. 6 illustrates an example of a process flow 600 that supports OAM multiplexing using different quantities of transmit and receive antenna subarrays in accordance with aspects of the present disclosure. The process flow 600 may implement or be implemented by aspects of the wireless communications systems 100 and 200. For example, the process flow 600 illustrates OAM communications between a device 605-a and a device 605-b, which may represent examples of corresponding devices as described with reference to FIGS. 2-5. The devices 605 may be UEs, base stations, IAB nodes, RUs, CUs, DUs, or any combination thereof, that support OAM communications. The device 605-a may include a first circular antenna array that includes a first quantity of antenna subarrays and the device 605-b may include a second circular antenna array that includes a second quantity of antenna subarrays, where the first and second quantities are different. The first circular antenna array and the second circular antenna array may be referred to as transmitter and receiver circles, respectively. Each antenna subarray may include one or more antenna elements. In some examples, the first quantity of antenna subarrays included in the transmitter circle may be an integer multiple of the second quantity of antenna subarrays included in the receiver circle, or the second quantity of antenna subarrays included in the receiver circle may be an integer multiple of the first quantity of antenna subarrays included in the transmitter circle.

In the following description of the process flow 600, the operations between the device 605-a and the device 605-b may be performed in different orders or at different times. Some operations may also be left out of the process flow 600, or other operations may be added. Although the device 605-a and the device 605-b are shown performing the operations of the process flow 600, some aspects of some operations may also be performed by one or more other wireless devices.

At 610, in some examples, one of the first device 605-a or the second device 605-b may group multiple sets of OAM weights into one or more groups. The groups may represent examples of the OAM mode groups 450 described with reference to FIG. 4. If the first quantity of antenna subarrays of the transmitter circle of the first device 605-a is equal to or the same as a product of the second quantity of antenna subarrays of the receiver circle of the second device 605-b and an integer factor, the first device 605-a may group the multiple sets of OAM weights into one or more groups, and the second device 605-b may refrain from grouping OAM weights. If the second quantity of antenna subarrays of the receiver circle of the second device 605-b is equal to or the same as a product of the first quantity of antenna subarrays of the transmitter circle of the first device 605-a and the integer factor, the second device 605-b may group the multiple sets of OAM weights into one or more groups, and the first device 605-a may refrain from grouping OAM weights. The respective device 605 may group the OAM weights based on the integer factor to obtain a quantity of groups of OAM weights that each include a same quantity of sets of OAM weights as the integer factor. In some examples, based on grouping the OAM weights, the respective device 605 may combine sets of OAM weights in each group based on the first quantity of antenna subarrays and the second quantity of antenna subarrays.

At 615, the first device 605-a may generate one or more signals for transmission from the first device 605-a to the second device 605-b via the transmitter circle of the first device 605-a. At 620, the first device 605-a may transmit the one or more signals (e.g., concurrently) to the second device 605-b using the transmitter circle and based on multiple OAM vectors. Each signal may be associated with a respective OAM vector of the multiple sets of OAM vectors (e.g., and a corresponding OAM mode, as described with reference to FIGS. 3 and 4). The multiple OAM vectors may be based on the receiver circle at the second device 605-b including the second quantity of antenna subarrays that is different than the first quantity of antenna subarrays included in the transmitter circle at the first device 605-a. In some examples, each OAM vector may include a respective set of one or more OAM weights.

A quantity of OAM vectors of the multiple OAM vectors may be equal to a minimum of the first quantity of antenna subarrays and the second quantity of antenna subarrays. In some examples, the multiple OAM vectors may be based on grouping OAM vectors at 610 (e.g., if the first device 605-a includes more antenna subarrays than the second device 605-b). Additionally or alternatively, the multiple OAM vectors may be based on the quantity of antenna subarrays included in the transmitter circle (e.g., if the quantity of antenna subarrays included in the transmitter circle is the same as the minimum of the first quantity and the second quantity).

At 625, the second device 605-b may decode the signals received using the receiver circle. The second device 605-b may decode the signals based on multiple OAM vectors at the second device. Each signal may be associated with a respective OAM vector of the multiple OAM vectors, and the multiple OAM vectors may be based on the receiver circle at the second device 605-b including the second quantity of antenna subarrays that is different than the first quantity of antenna subarrays included in the transmitter circle at the first device 605-a.

A quantity of OAM vectors of the multiple OAM vectors at the second device 605-b may be equal to a minimum of the first quantity of antenna subarrays and the second quantity of antenna subarrays, such that the first device 605-a and the second device 605-b may each determine a same quantity of OAM vectors. In some examples, the multiple OAM vectors may be based on grouping OAM vectors at 610 (e.g., if the second device 605-b includes more antenna subarrays than the first device 605-a). Additionally or alternatively, the multiple OAM vectors may be based on the quantity of antenna subarrays included in the receiver circle (e.g., if the quantity of antenna subarrays included in the receiver circle is the same as the minimum of the first quantity and the second quantity).

The first device 605-a and the second device 605-b may thereby support OAM beamforming and multiplexing using transmitter and receiver circles that include different quantities of antenna subarrays.

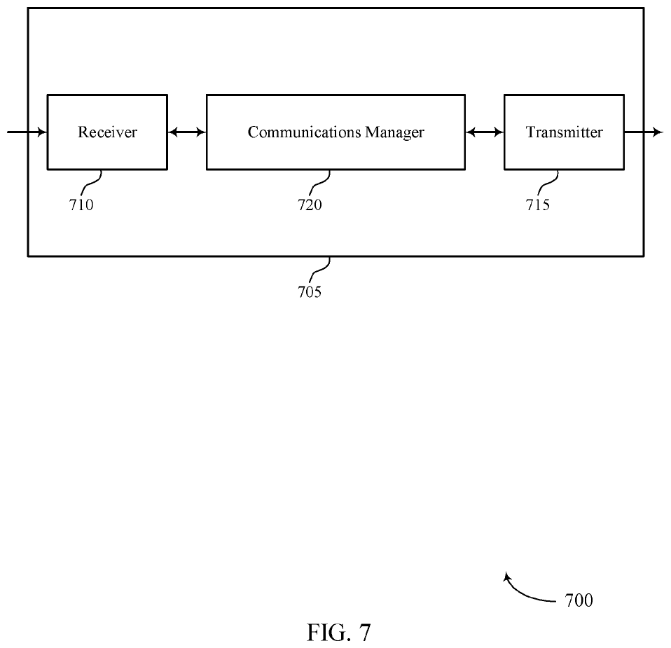

FIG. 7 shows a block diagram 700 of a device 705 that supports OAM multiplexing using different quantities of transmit and receive antenna subarrays in accordance with aspects of the present disclosure. The device 705 may be an example of aspects of a UE 115 or a Network Entity—ALPHA as described herein. The device 705 may include a receiver 710, a transmitter 715, and a communications manager 720. The device 705 may also include a processor. Each of these components may be in communication with one another (e.g., via one or more buses).

The receiver 710 may provide a means for receiving information such as packets, user data, control information, or any combination thereof associated with various information channels (e.g., control channels, data channels, information channels related to OAM multiplexing using different quantities of transmit and receive antenna subarrays). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to OAM multiplexing using different quantities of transmit and receive antenna subarrays). In some examples, the transmitter 715 may be co-located with a receiver 710 in a transceiver module. The transmitter 715 may utilize a single antenna or a set of multiple antennas.

The communications manager 720, the receiver 710, the transmitter 715, or various combinations thereof or various components thereof may be examples of means for performing various aspects of OAM multiplexing using different quantities of transmit and receive antenna subarrays as described herein. For example, the communications manager 720, the receiver 710, the transmitter 715, or various combinations or components thereof may support a method for performing one or more of the functions described herein.

In some examples, the communications manager 720, the receiver 710, the transmitter 715, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally or alternatively, in some examples, the communications manager 720, the receiver 710, the transmitter 715, or various combinations or components thereof may be implemented in code (e.g., as communications management software or firmware) executed by a processor. If implemented in code executed by a processor, the functions of the communications manager 720, the receiver 710, the transmitter 715, or various combinations or components thereof may be performed by a general-purpose processor, a DSP, a central processing unit (CPU), an ASIC, an FPGA, or any combination of these or other programmable logic devices (e.g., configured as or otherwise supporting a means for performing the functions described in the present disclosure).

In some examples, the communications manager 720 may be configured to perform various operations (e.g., receiving, monitoring, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to receive information, transmit information, or perform various other operations as described herein.

The communications manager 720 may support wireless communication at a first device in accordance with examples as disclosed herein. For example, the communications manager 720 may be configured as or otherwise support a means for generating one or more signals for transmission from the first device to a second device via a first circular antenna array that includes a first quantity of antenna subarrays, where each antenna subarray of the first circular antenna array includes one or more antenna elements. The communications manager 720 may be configured as or otherwise support a means for transmitting the one or more signals to the second device using the first circular antenna array and based on a set of multiple OAM vectors, where each signal of the one or more signals is associated with a respective OAM vector of the set of multiple OAM vectors, and where the set of multiple OAM vectors is based on a second circular antenna array at the second device including a second quantity of antenna subarrays that is different than the first quantity of antenna subarrays included in the first circular antenna array.

Additionally or alternatively, the communications manager 720 may support wireless communication at a second device in accordance with examples as disclosed herein. For example, the communications manager 720 may be configured as or otherwise support a means for receiving one or more signals from a first device using a second circular antenna array that includes a second quantity of antenna subarrays, where each antenna subarray of the second circular antenna array includes one or more antenna elements. The communications manager 720 may be configured as or otherwise support a means for decoding the one or more signals received using the second circular antenna array based on a set of multiple OAM vectors, where each signal of the one or more signals is associated with a respective OAM vector of the set of multiple OAM vectors, and where the set of multiple OAM vectors is based on a first circular antenna array at the first device including a first quantity of antenna subarrays that is different than the second quantity of antenna subarrays included in the second circular antenna array.

By including or configuring the communications manager 720 in accordance with examples as described herein, the device 705 (e.g., a processor controlling or otherwise coupled to the receiver 710, the transmitter 715, the communications manager 720, or a combination thereof) may support techniques for reduced complexity, reduced power consumption, efficient utilization of communication resources, and higher throughput. For example, if the device 705 and another device in communication with the device 705 are configured with quantities of OAM antenna subarrays that are integer multiples (e.g., M=KN or N=KM), the processor of the device 705 may identify eigenvalues of the M by N matrix with reduced complexity. The processor may thereby perform more accurate and efficient channel decoding to reduce power consumption and improve communication reliability. In some examples, an angular offset may be configured between an antenna subarray of the device 705 and an antenna subarray of the other device, which may reduce aliasing, improve throughput and improve data rates.

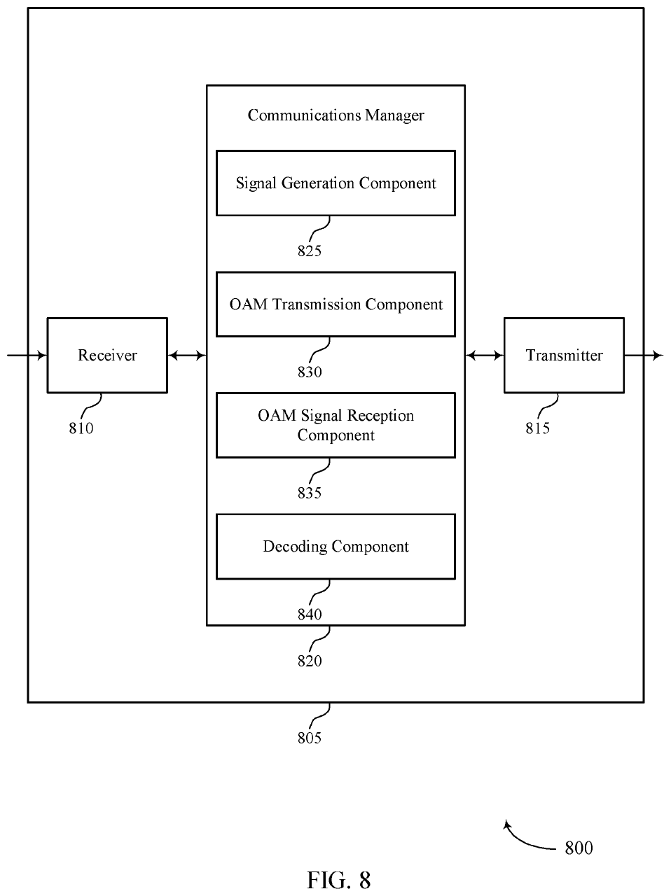

FIG. 8 shows a block diagram 800 of a device 805 that supports OAM multiplexing using different quantities of transmit and receive antenna subarrays in accordance with aspects of the present disclosure. The device 805 may be an example of aspects of a device 705, a UE 115, or a Network Entity—ALPHA 115 as described herein. The device 805 may include a receiver 810, a transmitter 815, and a communications manager 820. The device 805 may also include a processor. Each of these components may be in communication with one another (e.g., via one or more buses).

The receiver 810 may provide a means for receiving information such as packets, user data, control information, or any combination thereof associated with various information channels (e.g., control channels, data channels, information channels related to OAM multiplexing using different quantities of transmit and receive antenna subarrays). Information may be passed on to other components of the device 805. The receiver 810 may utilize a single antenna or a set of multiple antennas.

The transmitter 815 may provide a means for transmitting signals generated by other components of the device 805. For example, the transmitter 815 may transmit information such as packets, user data, control information, or any combination thereof associated with various information channels (e.g., control channels, data channels, information channels related to OAM multiplexing using different quantities of transmit and receive antenna subarrays). In some examples, the transmitter 815 may be co-located with a receiver 810 in a transceiver module. The transmitter 815 may utilize a single antenna or a set of multiple antennas.

The device 805, or various components thereof, may be an example of means for performing various aspects of OAM multiplexing using different quantities of transmit and receive antenna subarrays as described herein. For example, the communications manager 820 may include a signal generation component 825, a OAM transmission component 830, a OAM signal reception component 835, a decoding component 840, or any combination thereof. The communications manager 820 may be an example of aspects of a communications manager 720 as described herein. In some examples, the communications manager 820, or various components thereof, may be configured to perform various operations (e.g., receiving, monitoring, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to receive information, transmit information, or perform various other operations as described herein.

The communications manager 820 may support wireless communication at a first device in accordance with examples as disclosed herein. The signal generation component 825 may be configured as or otherwise support a means for generating one or more signals for transmission from the first device to a second device via a first circular antenna array that includes a first quantity of antenna subarrays, where each antenna subarray of the first circular antenna array includes one or more antenna elements. The OAM transmission component 830 may be configured as or otherwise support a means for transmitting the one or more signals to the second device using the first circular antenna array and based on a set of multiple OAM vectors, where each signal of the one or more signals is associated with a respective OAM vector of the set of multiple OAM vectors, and where the set of multiple OAM vectors is based on a second circular antenna array at the second device including a second quantity of antenna subarrays that is different than the first quantity of antenna subarrays included in the first circular antenna array.

Additionally or alternatively, the communications manager 820 may support wireless communication at a second device in accordance with examples as disclosed herein. The OAM signal reception component 835 may be configured as or otherwise support a means for receiving one or more signals from a first device using a second circular antenna array that includes a second quantity of antenna subarrays, where each antenna subarray of the second circular antenna array includes one or more antenna elements. The decoding component 840 may be configured as or otherwise support a means for decoding the one or more signals received using the second circular antenna array based on a set of multiple OAM vectors, where each signal of the one or more signals is associated with a respective OAM vector of the set of multiple OAM vectors, and where the set of multiple OAM vectors is based on a first circular antenna array at the first device including a first quantity of antenna subarrays that is different than the second quantity of antenna subarrays included in the second circular antenna array.

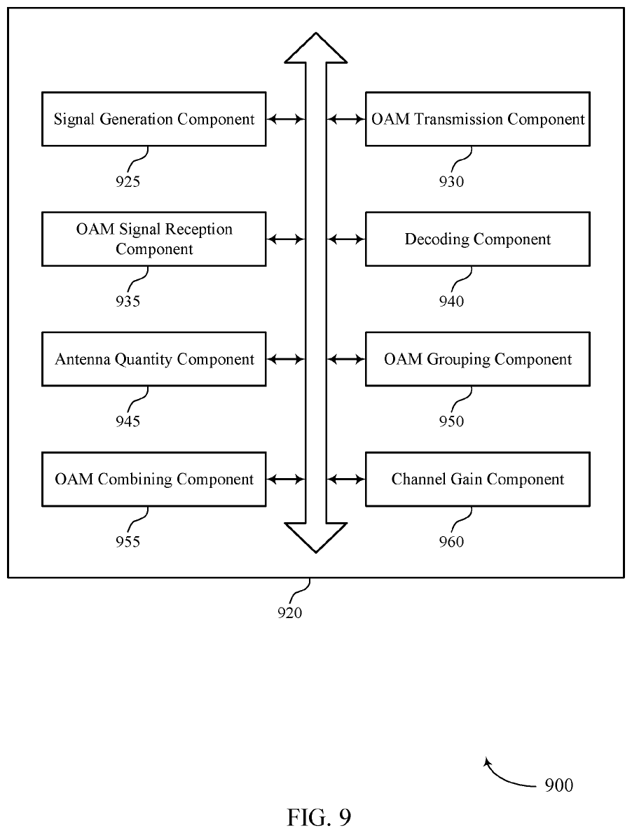

FIG. 9 shows a block diagram 900 of a communications manager 920 that supports OAM multiplexing using different quantities of transmit and receive antenna subarrays in accordance with aspects of the present disclosure. The communications manager 920 may be an example of aspects of a communications manager 720, a communications manager 820, or both, as described herein. The communications manager 920, or various components thereof, may be an example of means for performing various aspects of OAM multiplexing using different quantities of transmit and receive antenna subarrays as described herein. For example, the communications manager 920 may include a signal generation component 925, a OAM transmission component 930, a OAM signal reception component 935, a decoding component 940, an antenna quantity component 945, a OAM grouping component 950, a OAM combining component 955, a channel gain component 960, or any combination thereof. Each of these components may communicate, directly or indirectly, with one another (e.g., via one or more buses).

The communications manager 920 may support wireless communication at a first device in accordance with examples as disclosed herein. The signal generation component 925 may be configured as or otherwise support a means for generating one or more signals for transmission from the first device to a second device via a first circular antenna array that includes a first quantity of antenna subarrays, where each antenna subarray of the first circular antenna array includes one or more antenna elements. The OAM transmission component 930 may be configured as or otherwise support a means for transmitting the one or more signals to the second device using the first circular antenna array and based on a set of multiple OAM vectors, where each signal of the one or more signals is associated with a respective OAM vector of the set of multiple OAM vectors, and where the set of multiple OAM vectors is based on a second circular antenna array at the second device including a second quantity of antenna subarrays that is different than the first quantity of antenna subarrays included in the first circular antenna array.

In some examples, the first quantity of antenna subarrays included in the first circular antenna array being an integer multiple of the second quantity of antenna subarrays included in the second circular antenna array. In some examples, the second quantity of antenna subarrays included in the second circular antenna array being an integer multiple of the first quantity of antenna subarrays included in the first circular antenna array. In some examples, a quantity of OAM vectors within the set of multiple OAM vectors is equal to a minimum of the first quantity and the second quantity.

In some examples, the first quantity of antenna subarrays of the first circular antenna array is less than the second quantity of antenna subarrays of the second circular antenna array. In some examples, each OAM vector of the set of multiple OAM vectors includes a respective OAM weight for each antenna array of the first quantity of antenna subarrays based on the first quantity of antenna subarrays being less than the second quantity of antenna subarrays.

In some examples, the first quantity of antenna subarrays is equal to a product of the second quantity of antenna subarrays and an integer factor, and the OAM grouping component 950 may be configured as or otherwise support a means for grouping a second set of multiple OAM vectors into one or more groups based on the integer factor, where each group of the one or more groups includes a same quantity of OAM vectors, the same quantity equal to the integer factor. In some examples, the first quantity of antenna subarrays is equal to a product of the second quantity of antenna subarrays and an integer factor, and the OAM combining component 955 may be configured as or otherwise support a means for combining OAM vectors in each group to obtain the set of multiple OAM vectors.

In some examples, the OAM signal reception component 935 may be configured as or otherwise support a means for receiving, from the second device, a set of multiple reference signals using each antenna subarray of the first quantity of antenna subarrays within the first circular antenna array of the first device. In some examples, the channel gain component 960 may be configured as or otherwise support a means for estimating a set of multiple sets of channel gains based on the set of multiple reference signals, each set of channel gains of the set of multiple sets of channel gains including channel gains between antenna subarrays of the second quantity of antenna subarrays within the second circular antenna array of the second device and antenna subarrays of the first quantity of antenna subarrays within the first circular antenna array of the first device, and where the combining is based on the set of multiple sets of channel gains.

In some examples, the OAM transmission component 930 may be configured as or otherwise support a means for transmitting, to the second device, a set of multiple reference signals using each antenna subarray of the first quantity of antenna subarrays within the first circular antenna array of the first device. In some examples, the channel gain component 960 may be configured as or otherwise support a means for receiving, from the second device, an indication of a set of multiple sets of channel gains based on the set of multiple reference signals, each set of channel gains of the set of multiple sets of channel gains including channel gains between antenna subarrays of the second quantity of antenna subarrays within the second circular antenna array of the second device and antenna subarrays of the first quantity of antenna subarrays within the first circular antenna array of the first device, and where the combining is based on the set of multiple sets of channel gains.

In some examples, each antenna subarray of the first quantity of antenna subarrays within the first circular antenna array of the first device is located at a respective first angular offset relative to a first axis that bisects the first circular antenna array. In some examples, each antenna subarray of the second quantity of antenna subarrays within the second circular antenna array of the second device is located at a respective second angular offset relative to a second axis that bisects the second circular antenna array and is parallel to the first axis, each respective second angular offset different than each respective first angular offset, where a difference between the respective first angular offset for a first antenna subarray of the first quantity of antenna subarrays and the respective second angular offset for a second antenna subarray of the second quantity of antenna subarrays is based on the first quantity of antenna subarrays and the second quantity of antenna subarrays.

In some examples, the difference is based on a ratio between the first quantity and a minimum of the first quantity and the second quantity.

In some examples, the antenna quantity component 945 may be configured as or otherwise support a means for transmitting, to the second device, signaling that indicates the first quantity of antenna subarrays within the first circular antenna array of the first device. In some examples, the antenna quantity component 945 may be configured as or otherwise support a means for receiving, from the second device, signaling that indicates the second quantity of antenna subarrays within the second circular antenna array of the second device. In some examples, the antenna quantity component 945 may be configured as or otherwise support a means for any combination thereof.

In some examples, the antenna quantity component 945 may be configured as or otherwise support a means for determining the first quantity of antenna subarrays of the first circular antenna array based on a condition of a channel between the first device and the second device, a type of the first device, a capability of the first device, power consumption of the first device, or any combination thereof.

Additionally or alternatively, the communications manager 920 may support wireless communication at a second device in accordance with examples as disclosed herein. The OAM signal reception component 935 may be configured as or otherwise support a means for receiving one or more signals from a first device using a second circular antenna array that includes a second quantity of antenna subarrays, where each antenna subarray of the second circular antenna array includes one or more antenna elements. The decoding component 940 may be configured as or otherwise support a means for decoding the one or more signals received using the second circular antenna array based on a set of multiple OAM vectors, where each signal of the one or more signals is associated with a respective OAM vector of the set of multiple OAM vectors, and where the set of multiple OAM vectors is based on a first circular antenna array at the first device including a first quantity of antenna subarrays that is different than the second quantity of antenna subarrays included in the second circular antenna array.

In some examples, the set of multiple OAM vectors is based on the first quantity of antenna subarrays included in the first circular antenna array being an integer multiple of the second quantity of antenna subarrays included in the second circular antenna array or the second quantity of antenna subarrays included in the second circular antenna array being an integer multiple of the first quantity of antenna subarrays included in the first circular antenna array.

In some examples, a quantity of OAM vectors within the set of multiple OAM vectors is equal to a minimum of the first quantity and the second quantity. In some examples, the second quantity of antenna subarrays of the second circular antenna array is less than the first quantity of antenna subarrays of the first circular antenna array. In some examples, each OAM vector of the set of multiple OAM vectors includes a respective OAM weight for each antenna subarray of the second quantity of antenna subarrays based on the second quantity of antenna subarrays being less than the first quantity of antenna subarrays.

In some examples, the second quantity of antenna subarrays is equal to a product of the first quantity of antenna subarrays and an integer factor, and the OAM grouping component 950 may be configured as or otherwise support a means for grouping a second set of multiple OAM vectors into one or more groups based on the integer factor, where each group of the one or more groups includes a same quantity of OAM vectors, the same quantity equal to the integer factor. In some examples, the second quantity of antenna subarrays is equal to a product of the first quantity of antenna subarrays and an integer factor, and the OAM combining component 955 may be configured as or otherwise support a means for combining OAM vectors in each group to obtain the set of multiple OAM vectors.

In some examples, the OAM signal reception component 935 may be configured as or otherwise support a means for receiving, from the first device, a set of multiple reference signals using each antenna subarray of the second quantity of antenna subarrays within the second circular antenna array of the second device. In some examples, the channel gain component 960 may be configured as or otherwise support a means for estimating a set of multiple sets of channel gains based on the set of multiple reference signals, the set of multiple sets of channel gains including channel gains between antenna subarrays of the first quantity of antenna subarrays within the first circular antenna array of the first device and antenna subarrays of the second quantity of antenna subarrays within the second circular antenna array of the second device, and where the combining is based on the set of multiple sets of channel gains.

In some examples, the antenna quantity component 945 may be configured as or otherwise support a means for transmitting, to the first device, a set of multiple reference signals using each antenna subarray of the second quantity of antenna subarrays within the second circular antenna array of the second device. In some examples, the channel gain component 960 may be configured as or otherwise support a means for receiving, from the first device, an indication of a set of multiple sets of channel gains based on the set of multiple reference signals, each set of channel gains of the set of multiple sets of channel gains including channel gains between antenna subarrays of the first quantity of antenna subarrays within the first circular antenna array of the first device and antenna subarrays of the second quantity within the second circular antenna array of the second device, and where the combining is based on the set of multiple sets of channel gains.

In some examples, each antenna subarray of the first quantity of antenna subarrays within the first circular antenna array of the first device is located at a respective first angular offset relative to a first axis that bisects the first circular antenna array. In some examples, each antenna subarray of the second quantity of antenna subarrays within the second circular antenna array of the second device is located at a respective second angular offset relative to a second axis that bisects the second circular antenna array and is parallel to the first axis, each respective second angular offset different than each respective first angular offset, where a difference between the respective first angular offset for a first antenna subarray of the first quantity of antenna subarrays and the respective second angular offset for a second antenna subarray of the second quantity of antenna subarrays is based on the first quantity of antenna subarrays and the second quantity of antenna subarrays. In some examples, the difference is based on a ratio between the first quantity and a minimum of the first quantity and the second quantity.

In some examples, the antenna quantity component 945 may be configured as or otherwise support a means for transmitting, to the first device, signaling that indicates the second quantity of antenna subarrays within the second circular antenna array of the second device. In some examples, the antenna quantity component 945 may be configured as or otherwise support a means for receiving, from the first device, signaling that indicates the first quantity of antenna subarrays within the first circular antenna array of the first device. In some examples, the antenna quantity component 945 may be configured as or otherwise support a means for any combination thereof.

In some examples, the antenna quantity component 945 may be configured as or otherwise support a means for determining the second quantity of antenna subarrays of the second circular antenna array based on a condition of a channel between the second device and the first device, a type of the second device, a capability of the second device, power consumption of the second device, or any combination thereof.

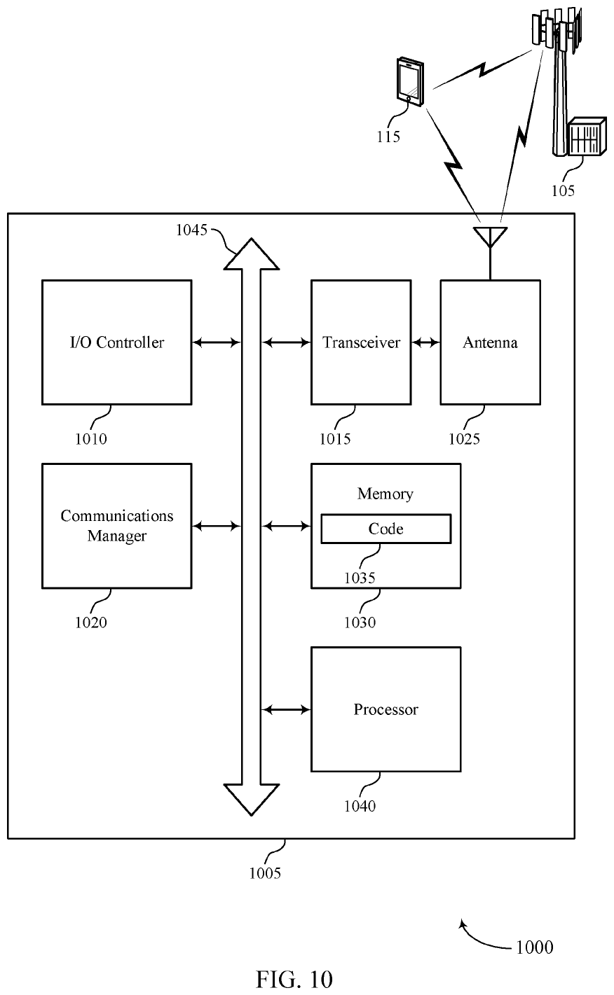

FIG. 10 shows a diagram of a system 1000 including a device 1005 that supports OAM multiplexing using different quantities of transmit and receive antenna subarrays in accordance with aspects of the present disclosure. The device 1005 may be an example of or include the components of a device 705, a device 805, or a UE 115 as described herein. The device 1005 may communicate wirelessly with one or more base stations 105, UEs 115, or any combination thereof. The device 1005 may include components for bi-directional voice and data communications including components for transmitting and receiving communications, such as a communications manager 1020, an input/output (I/O) controller 1010, a transceiver 1015, an antenna 1025, a memory 1030, code 1035, and a processor 1040. These components may be in electronic communication or otherwise coupled (e.g., operatively, communicatively, functionally, electronically, electrically) via one or more buses (e.g., a bus 1045).

The I/O controller 1010 may manage input and output signals for the device 1005. The I/O controller 1010 may also manage peripherals not integrated into the device 1005. In some cases, the I/O controller 1010 may represent a physical connection or port to an external peripheral. In some cases, the I/O controller 1010 may utilize an operating system such as iOS®, ANDROID®, MS-DOS®, MS-WINDOWS®, OS/2®, UNIX®, LINUX®, or another known operating system. Additionally or alternatively, the I/O controller 1010 may represent or interact with a modem, a keyboard, a mouse, a touchscreen, or a similar device. In some cases, the I/O controller 1010 may be implemented as part of a processor, such as the processor 1040. In some cases, a user may interact with the device 1005 via the I/O controller 1010 or via hardware components controlled by the I/O controller 1010.

In some cases, the device 1005 may include a single antenna 1025. However, in some other cases, the device 1005 may have more than one antenna 1025, which may be capable of concurrently transmitting or receiving multiple wireless transmissions. The transceiver 1015 may communicate bi-directionally, via the one or more antennas 1025, wired, or wireless links as described herein. For example, the transceiver 1015 may represent a wireless transceiver and may communicate bi-directionally with another wireless transceiver. The transceiver 1015 may also include a modem to modulate the packets, to provide the modulated packets to one or more antennas 1025 for transmission, and to demodulate packets received from the one or more antennas 1025. The transceiver 1015, or the transceiver 1015 and one or more antennas 1025, may be an example of a transmitter 715, a transmitter 815, a receiver 710, a receiver 810, or any combination thereof or component thereof, as described herein.

The memory 1030 may include random access memory (RAM) and read-only memory (ROM). The memory 1030 may store computer-readable, computer-executable code 1035 including instructions that, when executed by the processor 1040, cause the device 1005 to perform various functions described herein. The code 1035 may be stored in a non-transitory computer-readable medium such as system memory or another type of memory. In some cases, the code 1035 may not be directly executable by the processor 1040 but may cause a computer (e.g., when compiled and executed) to perform functions described herein. In some cases, the memory 1030 may contain, among other things, a basic I/O system (BIOS) which may control basic hardware or software operation such as the interaction with peripheral components or devices.

The processor 1040 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1040 may be configured to operate a memory array using a memory controller. In some other cases, a memory controller may be integrated into the processor 1040. The processor 1040 may be configured to execute computer-readable instructions stored in a memory (e.g., the memory 1030) to cause the device 1005 to perform various functions (e.g., functions or tasks supporting OAM multiplexing using different quantities of transmit and receive antenna subarrays). For example, the device 1005 or a component of the device 1005 may include a processor 1040 and memory 1030 coupled to the processor 1040, the processor 1040 and memory 1030 configured to perform various functions described herein.

The communications manager 1020 may support wireless communication at a first device in accordance with examples as disclosed herein. For example, the communications manager 1020 may be configured as or otherwise support a means for generating one or more signals for transmission from the first device to a second device via a first circular antenna array that includes a first quantity of antenna subarrays, where each antenna subarray of the first circular antenna array includes one or more antenna elements. The communications manager 1020 may be configured as or otherwise support a means for transmitting the one or more signals to the second device using the first circular antenna array and based on a set of multiple OAM vectors, where each signal of the one or more signals is associated with a respective OAM vector of the set of multiple OAM vectors, and where the set of multiple OAM vectors is based on a second circular antenna array at the second device including a second quantity of antenna subarrays that is different than the first quantity of antenna subarrays included in the first circular antenna array.

Additionally or alternatively, the communications manager 1020 may support wireless communication at a second device in accordance with examples as disclosed herein. For example, the communications manager 1020 may be configured as or otherwise support a means for receiving one or more signals from a first device using a second circular antenna array that includes a second quantity of antenna subarrays, where each antenna subarray of the second circular antenna array includes one or more antenna elements. The communications manager 1020 may be configured as or otherwise support a means for decoding the one or more signals received using the second circular antenna array based on a set of multiple OAM vectors, where each signal of the one or more signals is associated with a respective OAM vector of the set of multiple OAM vectors, and where the set of multiple OAM vectors is based on a first circular antenna array at the first device including a first quantity of antenna subarrays that is different than the second quantity of antenna subarrays included in the second circular antenna array.

By including or configuring the communications manager 1020 in accordance with examples as described herein, the device 1005 may support techniques for improved communication reliability, improved user experience related to reduced processing, reduced power consumption, and improved coordination between devices. The device 1005 may support a quantity of OAM antenna arrays that is an integer multiple of or evenly divisible by a quantity of OAM antenna arrays of another device in communication with the device 1005, which may provide for the device 1005 to identify applied weighting vectors with reduced complexity (e.g., as compared with solving a channel matrix). Such techniques may provide for reduced processing and latency and improved reliability and coordination between devices communicating according to an OAM communication scheme. In some examples, the device 1005 may signal a quantity of OAM antenna arrays at the device to another device, which may improve coordination between devices. Additionally or alternatively, an angular offset may be configured between antenna arrays of the device 1005 and antenna arrays of the other device, which may reduce aliasing and other interference to improve communication reliability.

In some examples, the communications manager 1020 may be configured to perform various operations (e.g., receiving, monitoring, transmitting) using or otherwise in cooperation with the transceiver 1015, the one or more antennas 1025, or any combination thereof. Although the communications manager 1020 is illustrated as a separate component, in some examples, one or more functions described with reference to the communications manager 1020 may be supported by or performed by the processor 1040, the memory 1030, the code 1035, or any combination thereof. For example, the code 1035 may include instructions executable by the processor 1040 to cause the device 1005 to perform various aspects of OAM multiplexing using different quantities of transmit and receive antenna subarrays as described herein, or the processor 1040 and the memory 1030 may be otherwise configured to perform or support such operations.

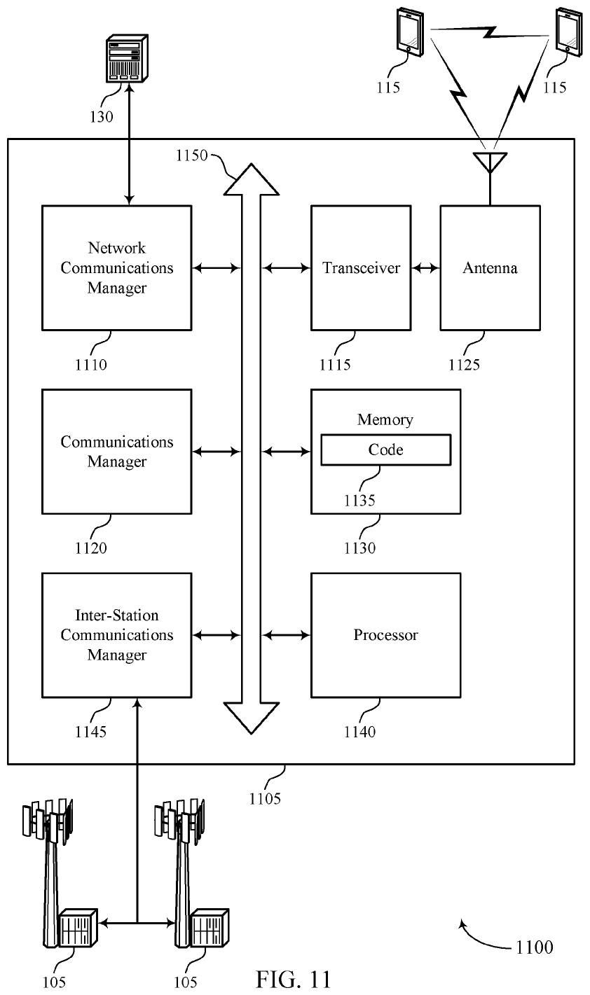

FIG. 11 shows a diagram of a system 1100 including a device 1105 that supports OAM multiplexing using different quantities of transmit and receive antenna subarrays in accordance with aspects of the present disclosure. The device 1105 may be an example of or include the components of a device 705, a device 805, or a Network Entity—ALPHA as described herein. The device 1105 may include components for bi-directional voice and data communications including components for transmitting and receiving communications, such as a communications manager 1120, a network communications manager 1110, a transceiver 1115, an antenna 1125, a memory 1130, code 1135, a processor 1140, and an inter-station communications manager 1145. These components may be in electronic communication or otherwise coupled (e.g., operatively, communicatively, functionally, electronically, electrically) via one or more buses (e.g., a bus 1150).

The network communications manager 1110 may manage communications with a core network 130 (e.g., via one or more wired backhaul links). For example, the network communications manager 1110 may manage the transfer of data communications for client devices, such as one or more UEs 115.

In some cases, the device 1105 may include a single antenna 1125. However, in some other cases the device 1105 may have more than one antenna 1125, which may be capable of concurrently transmitting or receiving multiple wireless transmissions. The transceiver 1115 may communicate bi-directionally, via the one or more antennas 1125, wired, or wireless links as described herein. For example, the transceiver 1115 may represent a wireless transceiver and may communicate bi-directionally with another wireless transceiver. The transceiver 1115 may also include a modem to modulate the packets, to provide the modulated packets to one or more antennas 1125 for transmission, and to demodulate packets received from the one or more antennas 1125. The transceiver 1115, or the transceiver 1115 and one or more antennas 1125, may be an example of a transmitter 715, a transmitter 815, a receiver 710, a receiver 810, or any combination thereof or component thereof, as described herein.

The memory 1130 may include RAM and ROM. The memory 1130 may store computer-readable, computer-executable code 1135 including instructions that, when executed by the processor 1140, cause the device 1105 to perform various functions described herein. The code 1135 may be stored in a non-transitory computer-readable medium such as system memory or another type of memory. In some cases, the code 1135 may not be directly executable by the processor 1140 but may cause a computer (e.g., when compiled and executed) to perform functions described herein. In some cases, the memory 1130 may contain, among other things, a BIOS which may control basic hardware or software operation such as the interaction with peripheral components or devices.

The processor 1140 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1140 may be configured to operate a memory array using a memory controller. In some other cases, a memory controller may be integrated into the processor 1140. The processor 1140 may be configured to execute computer-readable instructions stored in a memory (e.g., the memory 1130) to cause the device 1105 to perform various functions (e.g., functions or tasks supporting OAM multiplexing using different quantities of transmit and receive antenna subarrays). For example, the device 1105 or a component of the device 1105 may include a processor 1140 and memory 1130 coupled to the processor 1140, the processor 1140 and memory 1130 configured to perform various functions described herein.

The inter-station communications manager 1145 may manage communications with other base stations 105, and may include a controller or scheduler for controlling communications with UEs 115 in cooperation with other base stations 105. For example, the inter-station communications manager 1145 may coordinate scheduling for transmissions to UEs 115 for various interference mitigation techniques such as beamforming or joint transmission. In some examples, the inter-station communications manager 1145 may provide an X2 interface within an LTE/LTE-A wireless communications network technology to provide communication between base stations 105.

The communications manager 1120 may support wireless communication at a first device in accordance with examples as disclosed herein. For example, the communications manager 1120 may be configured as or otherwise support a means for generating one or more signals for transmission from the first device to a second device via a first circular antenna array that includes a first quantity of antenna subarrays, where each antenna subarray of the first circular antenna array includes one or more antenna elements. The communications manager 1120 may be configured as or otherwise support a means for transmitting the one or more signals to the second device using the first circular antenna array and based on a set of multiple OAM vectors, where each signal of the one or more signals is associated with a respective OAM vector of the set of multiple OAM vectors, and where the set of multiple OAM vectors is based on a second circular antenna array at the second device including a second quantity of antenna subarrays that is different than the first quantity of antenna subarrays included in the first circular antenna array.

Additionally or alternatively, the communications manager 1120 may support wireless communication at a second device in accordance with examples as disclosed herein. For example, the communications manager 1120 may be configured as or otherwise support a means for receiving one or more signals from a first device using a second circular antenna array that includes a second quantity of antenna subarrays, where each antenna subarray of the second circular antenna array includes one or more antenna elements. The communications manager 1120 may be configured as or otherwise support a means for decoding the one or more signals received using the second circular antenna array based on a set of multiple OAM vectors, where each signal of the one or more signals is associated with a respective OAM vector of the set of multiple OAM vectors, and where the set of multiple OAM vectors is based on a first circular antenna array at the first device including a first quantity of antenna subarrays that is different than the second quantity of antenna subarrays included in the second circular antenna array.

By including or configuring the communications manager 1120 in accordance with examples as described herein, the device 1105 may support techniques for improved communication reliability, improved user experience related to reduced processing, reduced power consumption, and improved coordination between devices. The device 1105 may support a quantity of OAM antenna subarrays that is an integer multiple of or evenly divisible by a quantity of OAM antenna subarrays of another device in communication with the device 1105, which may provide for the device 1105 to identify applied weighting vectors with reduced complexity (e.g., as compared with solving a channel matrix). Such techniques may provide for reduced processing and latency and improved reliability and coordination between devices communicating according to an OAM communication scheme. In some examples, the device 1105 may signal a quantity of OAM antenna subarrays at the device to another device, which may improve coordination between devices. Additionally or alternatively, an angular offset may be configured between antenna subarrays of the device 1105 and antenna subarrays of the other device, which may reduce aliasing and other interference to improve communication reliability.

In some examples, the communications manager 1120 may be configured to perform various operations (e.g., receiving, monitoring, transmitting) using or otherwise in cooperation with the transceiver 1115, the one or more antennas 1125, or any combination thereof. Although the communications manager 1120 is illustrated as a separate component, in some examples, one or more functions described with reference to the communications manager 1120 may be supported by or performed by the processor 1140, the memory 1130, the code 1135, or any combination thereof. For example, the code 1135 may include instructions executable by the processor 1140 to cause the device 1105 to perform various aspects of OAM multiplexing using different quantities of transmit and receive antenna subarrays as described herein, or the processor 1140 and the memory 1130 may be otherwise configured to perform or support such operations.

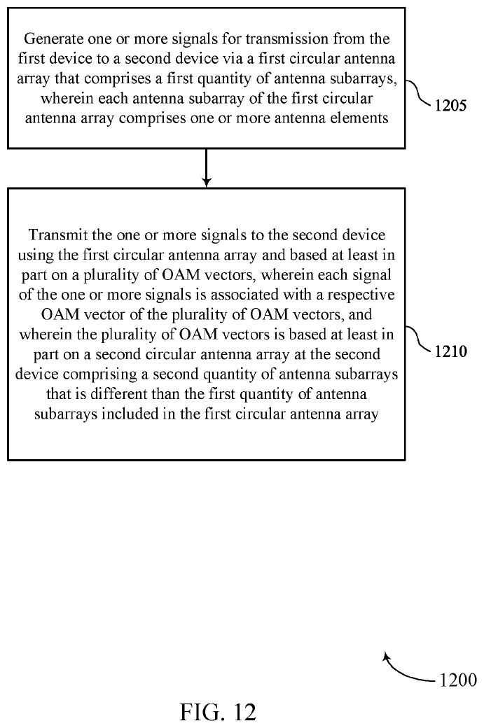

FIG. 12 shows a flowchart illustrating a method 1200 that supports OAM multiplexing using different quantities of transmit and receive antenna subarrays in accordance with aspects of the present disclosure. The operations of the method 1200 may be implemented by a UE or a Network Entity—ALPHA or its components as described herein. For example, the operations of the method 1200 may be performed by a UE 115 or a Network Entity—ALPHA as described with reference to FIGS. 1 through 11. In some examples, a UE or a Network Entity—ALPHA may execute a set of instructions to control the functional elements of the UE or the Network Entity—ALPHA to perform the described functions. Additionally or alternatively, the UE or the Network Entity—ALPHA may perform aspects of the described functions using special-purpose hardware.

At 1205, the method may include generating one or more signals for transmission from the first device to a second device via a first circular antenna array that includes a first quantity of antenna subarrays, where each antenna subarray of the first circular antenna array includes one or more antenna elements. The operations of 1205 may be performed in accordance with examples as disclosed herein. In some examples, aspects of the operations of 1205 may be performed by a signal generation component 925 as described with reference to FIG. 9.

At 1210, the method may include transmitting the one or more signals to the second device using the first circular antenna array and based on a set of multiple OAM vectors, where each signal of the one or more signals is associated with a respective OAM vector of the set of multiple OAM vectors, and where the set of multiple OAM vectors is based on a second circular antenna array at the second device including a second quantity of antenna subarrays that is different than the first quantity of antenna subarrays included in the first circular antenna array. The operations of 1210 may be performed in accordance with examples as disclosed herein. In some examples, aspects of the operations of 1210 may be performed by a OAM transmission component 930 as described with reference to FIG. 9.

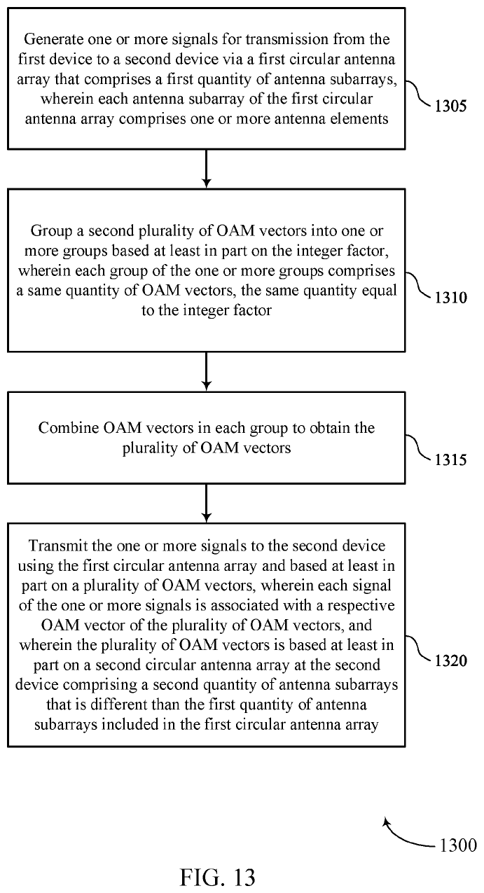

FIG. 13 shows a flowchart illustrating a method 1300 that supports OAM multiplexing using different quantities of transmit and receive antenna subarrays in accordance with aspects of the present disclosure. The operations of the method 1300 may be implemented by a UE or a Network Entity—ALPHA or its components as described herein. For example, the operations of the method 1300 may be performed by a UE 115 or a Network Entity—ALPHA as described with reference to FIGS. 1 through 11. In some examples, a UE or a Network Entity—ALPHA may execute a set of instructions to control the functional elements of the UE or the Network Entity—ALPHA to perform the described functions. Additionally or alternatively, the UE or the Network Entity—ALPHA may perform aspects of the described functions using special-purpose hardware.

At 1305, the method may include generating one or more signals for transmission from the first device to a second device via a first circular antenna array that includes a first quantity of antenna subarrays, where each antenna subarray of the first circular antenna array includes one or more antenna elements. The operations of 1305 may be performed in accordance with examples as disclosed herein. In some examples, aspects of the operations of 1305 may be performed by a signal generation component 925 as described with reference to FIG. 9.

At 1310, the method may include grouping a second set of multiple OAM vectors into one or more groups based on the integer factor, where each group of the one or more groups includes a same quantity of OAM vectors, the same quantity equal to the integer factor. The operations of 1310 may be performed in accordance with examples as disclosed herein. In some examples, aspects of the operations of 1310 may be performed by a OAM grouping component 950 as described with reference to FIG. 9.

At 1315, the method may include combining OAM vectors in each group to obtain the set of multiple OAM vectors. The operations of 1315 may be performed in accordance with examples as disclosed herein. In some examples, aspects of the operations of 1315 may be performed by a OAM combining component 955 as described with reference to FIG. 9.

At 1320, the method may include transmitting the one or more signals to the second device using the first circular antenna array and based on a set of multiple OAM vectors, where each signal of the one or more signals is associated with a respective OAM vector of the set of multiple OAM vectors, and where the set of multiple OAM vectors is based on a second circular antenna array at the second device including a second quantity of antenna subarrays that is different than the first quantity of antenna subarrays included in the first circular antenna array. The operations of 1320 may be performed in accordance with examples as disclosed herein. In some examples, aspects of the operations of 1320 may be performed by a OAM transmission component 930 as described with reference to FIG. 9.

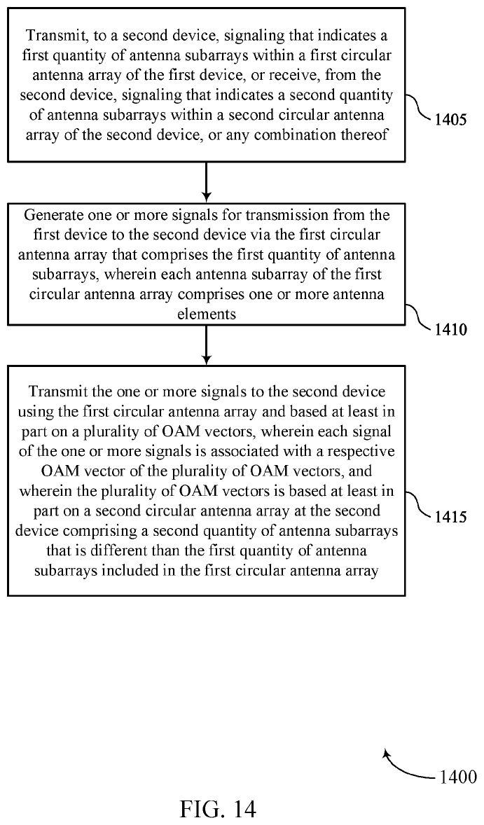

FIG. 14 shows a flowchart illustrating a method 1400 that supports OAM multiplexing using different quantities of transmit and receive antenna subarrays in accordance with aspects of the present disclosure. The operations of the method 1400 may be implemented by a UE or a Network Entity—ALPHA or its components as described herein. For example, the operations of the method 1400 may be performed by a UE 115 or a Network Entity—ALPHA as described with reference to FIGS. 1 through 11. In some examples, a UE or a Network Entity—ALPHA may execute a set of instructions to control the functional elements of the UE or the Network Entity—ALPHA to perform the described functions. Additionally or alternatively, the UE or the Network Entity—ALPHA may perform aspects of the described functions using special-purpose hardware.

At 1405, the method may include transmitting, to a second device, signaling that indicates a first quantity of antenna subarrays within a first circular antenna array of the first device, or receiving, from the second device, signaling that indicates a second quantity of antenna subarrays within a second circular antenna array of the second device, or any combination thereof. The operations of 1405 may be performed in accordance with examples as disclosed herein. In some examples, aspects of the operations of 1405 may be performed by an antenna quantity component 945 as described with reference to FIG. 9.

At 1410, the method may include generating one or more signals for transmission from the first device to the second device via the first circular antenna array that includes the first quantity of antenna subarrays, where each antenna subarray of the first circular antenna array includes one or more antenna elements. The operations of 1410 may be performed in accordance with examples as disclosed herein. In some examples, aspects of the operations of 1410 may be performed by a signal generation component 925 as described with reference to FIG. 9.

At 1415, the method may include transmitting the one or more signals to the second device using the first circular antenna array and based on a set of multiple OAM vectors, where each signal of the one or more signals is associated with a respective OAM vector of the set of multiple OAM vectors, and where the set of multiple OAM vectors is based on a second circular antenna array at the second device including a second quantity of antenna subarrays that is different than the first quantity of antenna subarrays included in the first circular antenna array. The operations of 1415 may be performed in accordance with examples as disclosed herein. In some examples, aspects of the operations of 1415 may be performed by a OAM transmission component 930 as described with reference to FIG. 9.

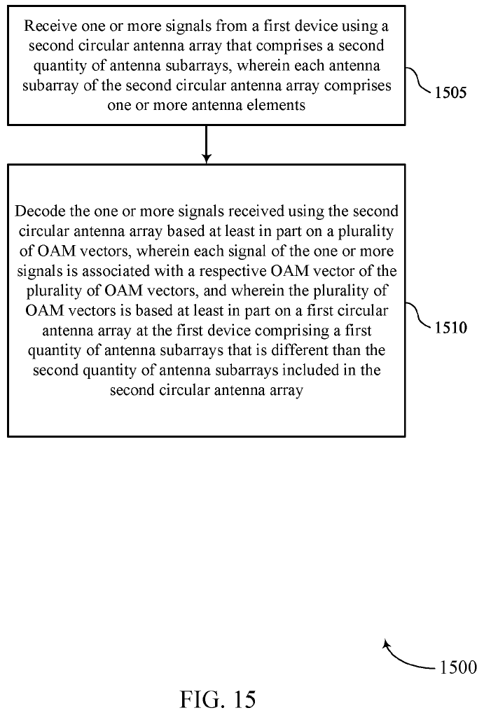

FIG. 15 shows a flowchart illustrating a method 1500 that supports OAM multiplexing using different quantities of transmit and receive antenna subarrays in accordance with aspects of the present disclosure. The operations of the method 1500 may be implemented by a UE or a Network Entity—ALPHA or its components as described herein. For example, the operations of the method 1500 may be performed by a UE 115 or a Network Entity—ALPHA as described with reference to FIGS. 1 through 11. In some examples, a UE or a Network Entity—ALPHA may execute a set of instructions to control the functional elements of the UE or the Network Entity—ALPHA to perform the described functions. Additionally or alternatively, the UE or the Network Entity—ALPHA may perform aspects of the described functions using special-purpose hardware.

At 1505, the method may include receiving one or more signals from a first device using a second circular antenna array that includes a second quantity of antenna subarrays, where each antenna subarray of the second circular antenna array includes one or more antenna elements. The operations of 1505 may be performed in accordance with examples as disclosed herein. In some examples, aspects of the operations of 1505 may be performed by a OAM signal reception component 935 as described with reference to FIG. 9.

At 1510, the method may include decoding the one or more signals received using the second circular antenna array based on a set of multiple OAM vectors, where each signal of the one or more signals is associated with a respective OAM vector of the set of multiple OAM vectors, and where the set of multiple OAM vectors is based on a first circular antenna array at the first device including a first quantity of antenna subarrays that is different than the second quantity of antenna subarrays included in the second circular antenna array. The operations of 1510 may be performed in accordance with examples as disclosed herein. In some examples, aspects of the operations of 1510 may be performed by a decoding component 940 as described with reference to FIG. 9.

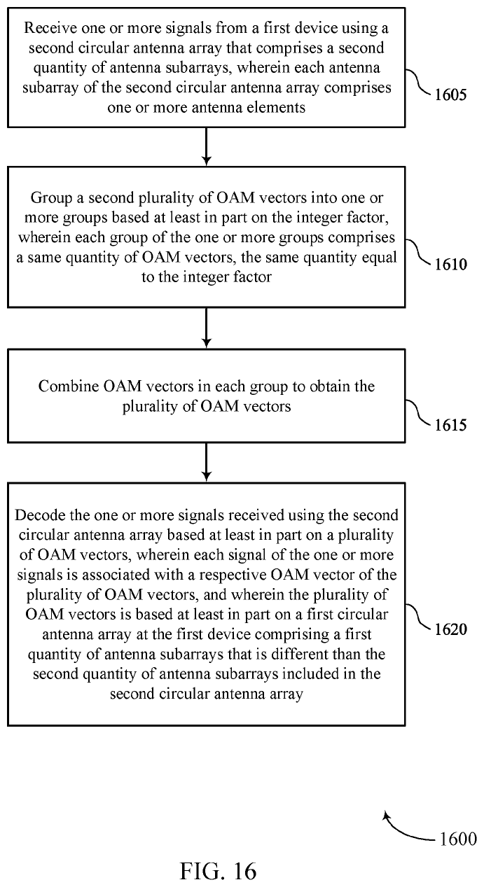

FIG. 16 shows a flowchart illustrating a method 1600 that supports OAM multiplexing using different quantities of transmit and receive antenna subarrays in accordance with aspects of the present disclosure. The operations of the method 1600 may be implemented by a UE or a Network Entity—ALPHA or its components as described herein. For example, the operations of the method 1600 may be performed by a UE 115 or a Network Entity—ALPHA as described with reference to FIGS. 1 through 11. In some examples, a UE or a Network Entity—ALPHA may execute a set of instructions to control the functional elements of the UE or the Network Entity—ALPHA to perform the described functions. Additionally or alternatively, the UE or the Network Entity—ALPHA may perform aspects of the described functions using special-purpose hardware.

At 1605, the method may include receiving one or more signals from a first device using a second circular antenna array that includes a second quantity of antenna subarrays, where each antenna subarray of the second circular antenna array includes one or more antenna elements. The operations of 1605 may be performed in accordance with examples as disclosed herein. In some examples, aspects of the operations of 1605 may be performed by a OAM signal reception component 935 as described with reference to FIG. 9.

At 1610, the method may include grouping a second set of multiple OAM vectors into one or more groups based on the integer factor, where each group of the one or more groups includes a same quantity of OAM vectors, the same quantity equal to the integer factor. The operations of 1610 may be performed in accordance with examples as disclosed herein. In some examples, aspects of the operations of 1610 may be performed by a OAM grouping component 950 as described with reference to FIG. 9.

At 1615, the method may include combining OAM vectors in each group to obtain the set of multiple OAM vectors. The operations of 1615 may be performed in accordance with examples as disclosed herein. In some examples, aspects of the operations of 1615 may be performed by a OAM combining component 955 as described with reference to FIG. 9.

At 1620, the method may include decoding the one or more signals received using the second circular antenna array based on a set of multiple OAM vectors, where each signal of the one or more signals is associated with a respective OAM vector of the set of multiple OAM vectors, and where the set of multiple OAM vectors is based on a first circular antenna array at the first device including a first quantity of antenna subarrays that is different than the second quantity of antenna subarrays included in the second circular antenna array. The operations of 1620 may be performed in accordance with examples as disclosed herein. In some examples, aspects of the operations of 1620 may be performed by a decoding component 940 as described with reference to FIG. 9.

The following provides an overview of aspects of the present disclosure:

Aspect 1: A method for wireless communication at a first device, comprising: generating one or more signals for transmission from the first device to a second device via a first circular antenna array that comprises a first quantity of antenna subarrays, wherein each antenna subarray of the first circular antenna array comprises one or more antenna elements; and transmitting the one or more signals to the second device using the first circular antenna array and based at least in part on a plurality of OAM vectors, wherein each signal of the one or more signals is associated with a respective OAM vector of the plurality of OAM vectors, and wherein the plurality of OAM vectors is based at least in part on a second circular antenna array at the second device comprising a second quantity of antenna subarrays that is different than the first quantity of antenna subarrays included in the first circular antenna array.

Aspect 2: The method of aspect 1, wherein the plurality of OAM vectors is based at least in part on the first quantity of antenna subarrays included in the first circular antenna array being an integer multiple of the second quantity of antenna subarrays included in the second circular antenna array, or the second quantity of antenna subarrays included in the second circular antenna array being an integer multiple of the first quantity of antenna subarrays included in the first circular antenna array.

Aspect 3: The method of any of aspects 1 through 2, wherein a quantity of OAM vectors within the plurality of OAM vectors is equal to a minimum of the first quantity and the second quantity.

Aspect 4: The method of any of aspects 1 through 3, wherein the first quantity of antenna subarrays of the first circular antenna array is less than the second quantity of antenna subarrays of the second circular antenna array; and each OAM vector of the plurality of OAM vectors comprises a respective OAM weight for each antenna array of the first quantity of antenna subarrays based at least in part on the first quantity of antenna subarrays being less than the second quantity of antenna subarrays.

Aspect 5: The method of any of aspects 1 through 3, wherein the first quantity of antenna subarrays is equal to a product of the second quantity of antenna subarrays and an integer factor, the method further comprising: grouping a second plurality of OAM vectors into one or more groups based at least in part on the integer factor, wherein each group of the one or more groups comprises a same quantity of OAM vectors, the same quantity equal to the integer factor; and combining OAM vectors in each group to obtain the plurality of OAM vectors.

Aspect 6: The method of aspect 5, further comprising: receiving, from the second device, a plurality of reference signals using each antenna subarray of the first quantity of antenna subarrays within the first circular antenna array of the first device; and estimating a plurality of sets of channel gains based at least in part on the plurality of reference signals, each set of channel gains of the plurality of sets of channel gains comprising channel gains between antenna subarrays of the second quantity of antenna subarrays within the second circular antenna array of the second device and antenna subarrays of the first quantity of antenna subarrays within the first circular antenna array of the first device, and wherein the combining is based at least in part on the plurality of sets of channel gains.

Aspect 7: The method of aspect 5, further comprising: transmitting, to the second device, a plurality of reference signals using each antenna subarray of the first quantity of antenna subarrays within the first circular antenna array of the first device; and receiving, from the second device, an indication of a plurality of sets of channel gains based at least in part on the plurality of reference signals, each set of channel gains of the plurality of sets of channel gains comprising channel gains between antenna subarrays of the second quantity of antenna subarrays within the second circular antenna array of the second device and antenna subarrays of the first quantity of antenna subarrays within the first circular antenna array of the first device, and wherein the combining is based at least in part on the plurality of sets of channel gains.

Aspect 8: The method of any of aspects 1 through 7, wherein each antenna subarray of the first quantity of antenna subarrays within the first circular antenna array of the first device is located at a respective first angular offset relative to a first axis that bisects the first circular antenna array; and each antenna subarray of the second quantity of antenna subarrays within the second circular antenna array of the second device is located at a respective second angular offset relative to a second axis that bisects the second circular antenna array and is parallel to the first axis, each respective second angular offset different than each respective first angular offset, wherein a difference between the respective first angular offset for a first antenna subarray of the first quantity of antenna subarrays and the respective second angular offset for a second antenna subarray of the second quantity of antenna subarrays is based at least in part on the first quantity of antenna subarrays and the second quantity of antenna subarrays.

Aspect 9: The method of aspect 8, wherein the difference is based at least in part on a ratio between the first quantity and a minimum of the first quantity and the second quantity.

Aspect 10: The method of any of aspects 1 through 9, further comprising: transmitting, to the second device, signaling that indicates the first quantity of antenna subarrays within the first circular antenna array of the first device; or receiving, from the second device, signaling that indicates the second quantity of antenna subarrays within the second circular antenna array of the second device; or any combination thereof.

Aspect 11: The method of any of aspects 1 through 10, further comprising: determining the first quantity of antenna subarrays of the first circular antenna array based at least in part on a condition of a channel between the first device and the second device, a type of the first device, a capability of the first device, power consumption of the first device, or any combination thereof.

Aspect 12: A method for wireless communication at a second device, comprising: receiving one or more signals from a first device using a second circular antenna array that comprises a second quantity of antenna subarrays, wherein each antenna subarray of the second circular antenna array comprises one or more antenna elements; and decoding the one or more signals received using the second circular antenna array based at least in part on a plurality of OAM vectors, wherein each signal of the one or more signals is associated with a respective OAM vector of the plurality of OAM vectors, and wherein the plurality of OAM vectors is based at least in part on a first circular antenna array at the first device comprising a first quantity of antenna subarrays that is different than the second quantity of antenna subarrays included in the second circular antenna array.

Aspect 13: The method of aspect 12, wherein the plurality of OAM vectors is based at least in part on the first quantity of antenna subarrays included in the first circular antenna array being an integer multiple of the second quantity of antenna subarrays included in the second circular antenna array or the second quantity of antenna subarrays included in the second circular antenna array being an integer multiple of the first quantity of antenna subarrays included in the first circular antenna array.

Aspect 14: The method of any of aspects 12 through 13, wherein a quantity of OAM vectors within the plurality of OAM vectors is equal to a minimum of the first quantity and the second quantity.

Aspect 15: The method of any of aspects 12 through 14, wherein the second quantity of antenna subarrays of the second circular antenna array is less than the first quantity of antenna subarrays of the first circular antenna array; and each OAM vector of the plurality of OAM vectors comprises a respective OAM weight for each antenna subarray of the second quantity of antenna subarrays based at least in part on the second quantity of antenna subarrays being less than the first quantity of antenna subarrays.

Aspect 16: The method of any of aspects 12 through 14, wherein the second quantity of antenna subarrays is equal to a product of the first quantity of antenna subarrays and an integer factor, the method further comprising: grouping a second plurality of OAM vectors into one or more groups based at least in part on the integer factor, wherein each group of the one or more groups comprises a same quantity of OAM vectors, the same quantity equal to the integer factor; and combining OAM vectors in each group to obtain the plurality of OAM vectors.

Aspect 17: The method of aspect 16, further comprising: receiving, from the first device, a plurality of reference signals using each antenna subarray of the second quantity of antenna subarrays within the second circular antenna array of the second device; and estimating a plurality of sets of channel gains based at least in part on the plurality of reference signals, the plurality of sets of channel gains comprising channel gains between antenna subarrays of the first quantity of antenna subarrays within the first circular antenna array of the first device and antenna subarrays of the second quantity of antenna subarrays within the second circular antenna array of the second device, and wherein the combining is based at least in part on the plurality of sets of channel gains.

Aspect 18: The method of aspect 16, further comprising: transmitting, to the first device, a plurality of reference signals using each antenna subarray of the second quantity of antenna subarrays within the second circular antenna array of the second device; and receiving, from the first device, an indication of a plurality of sets of channel gains based at least in part on the plurality of reference signals, each set of channel gains of the plurality of sets of channel gains comprising channel gains between antenna subarrays of the first quantity of antenna subarrays within the first circular antenna array of the first device and antenna subarrays of the second quantity within the second circular antenna array of the second device, and wherein the combining is based at least in part on the plurality of sets of channel gains.

Aspect 19: The method of any of aspects 12 through 18, wherein each antenna subarray of the first quantity of antenna subarrays within the first circular antenna array of the first device is located at a respective first angular offset relative to a first axis that bisects the first circular antenna array; and each antenna subarray of the second quantity of antenna subarrays within the second circular antenna array of the second device is located at a respective second angular offset relative to a second axis that bisects the second circular antenna array and is parallel to the first axis, each respective second angular offset different than each respective first angular offset, wherein a difference between the respective first angular offset for a first antenna subarray of the first quantity of antenna subarrays and the respective second angular offset for a second antenna subarray of the second quantity of antenna subarrays is based at least in part on the first quantity of antenna subarrays and the second quantity of antenna subarrays.

Aspect 20: The method of aspect 19, wherein the difference is based at least in part on a ratio between the first quantity and a minimum of the first quantity and the second quantity.

Aspect 21: The method of any of aspects 12 through 20, further comprising: transmitting, to the first device, signaling that indicates the second quantity of antenna subarrays within the second circular antenna array of the second device; or receiving, from the first device, signaling that indicates the first quantity of antenna subarrays within the first circular antenna array of the first device; or any combination thereof.

Aspect 22: The method of any of aspects 12 through 21, further comprising: determining the second quantity of antenna subarrays of the second circular antenna array based at least in part on a condition of a channel between the second device and the first device, a type of the second device, a capability of the second device, power consumption of the second device, or any combination thereof.

Aspect 23: An apparatus for wireless communication, comprising: a processor of a first device, a first circular antenna array that comprises a first quantity of antenna subarrays, wherein each antenna subarray of the first circular antenna array comprises one or more antenna elements; and memory coupled with the processor, the memory and the processor configured to cause the apparatus to perform a method of any of aspects 1 through 11.

Aspect 24: An apparatus for wireless communication at a first device, comprising at least one means for performing a method of any of aspects 1 through 11.

Aspect 25: A non-transitory computer-readable medium storing code for wireless communication at a first device, the code comprising instructions executable by a processor to perform a method of any of aspects 1 through 11.

Aspect 26: An apparatus for wireless communication, comprising a processor of a second device, a second circular antenna array that comprises a second quantity of antenna subarrays, wherein each antenna subarray of the second circular antenna array comprises one or more antenna elements; and memory coupled with the processor, the memory and the processor configured to cause the apparatus to perform a method of any of aspects 12 through 22.

Aspect 27: An apparatus for wireless communication at a second device, comprising at least one means for performing a method of any of aspects 12 through 22.

Aspect 28: A non-transitory computer-readable medium storing code for wireless communication at a second device, the code comprising instructions executable by a processor to perform a method of any of aspects 12 through 22.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a wide variety of actions and, therefore, “determining” can include calculating, computing, processing, deriving, investigating, looking up (such as via looking up in a table, a database or another data structure), ascertaining and the like. Also, “determining” can include receiving (such as receiving information), accessing (such as accessing data in a memory) and the like. Also, “determining” can include resolving, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method for wireless communication at a first device, comprising:
generating one or more signals for transmission from the first device to a second device via a first circular antenna array that comprises a first quantity of antenna subarrays, wherein each antenna subarray of the first circular antenna array comprises one or more antenna elements; and
transmitting the one or more signals to the second device using the first circular antenna array and based at least in part on a plurality of orbital angular momentum vectors, wherein each signal of the one or more signals is associated with a respective orbital angular momentum vector of the plurality of orbital angular momentum vectors, and wherein the plurality of orbital angular momentum vectors is based at least in part on a second circular antenna array at the second device comprising a second quantity of antenna subarrays that is different than the first quantity of antenna subarrays included in the first circular antenna array.

2. The method of claim 1, wherein the plurality of orbital angular momentum vectors is based at least in part on:
the first quantity of antenna subarrays included in the first circular antenna array being an integer multiple of the second quantity of antenna subarrays included in the second circular antenna array, or
the second quantity of antenna subarrays included in the second circular antenna array being an integer multiple of the first quantity of antenna subarrays included in the first circular antenna array.

3. The method of claim 1, wherein a quantity of orbital angular momentum vectors within the plurality of orbital angular momentum vectors is equal to a minimum of the first quantity and the second quantity.

4. The method of claim 1, wherein:
the first quantity of antenna subarrays of the first circular antenna array is less than the second quantity of antenna subarrays of the second circular antenna array; and
each orbital angular momentum vector of the plurality of orbital angular momentum vectors comprises a respective orbital angular momentum weight for each antenna array of the first quantity of antenna subarrays based at least in part on the first quantity of antenna subarrays being less than the second quantity of antenna subarrays.

5. The method of claim 1, wherein the first quantity of antenna subarrays is equal to a product of the second quantity of antenna subarrays and an integer factor, the method further comprising:
grouping a second plurality of orbital angular momentum vectors into one or more groups based at least in part on the integer factor, wherein each group of the one or more groups comprises a same quantity of orbital angular momentum vectors, the same quantity equal to the integer factor; and
combining orbital angular momentum vectors in each group to obtain the plurality of orbital angular momentum vectors.

6. The method of claim 5, further comprising:
receiving, from the second device, a plurality of reference signals using each antenna subarray of the first quantity of antenna subarrays within the first circular antenna array of the first device; and
estimating a plurality of sets of channel gains based at least in part on the plurality of reference signals, each set of channel gains of the plurality of sets of channel gains comprising channel gains between antenna subarrays of the second quantity of antenna subarrays within the second circular antenna array of the second device and antenna subarrays of the first quantity of antenna subarrays within the first circular antenna array of the first device, and wherein the combining is based at least in part on the plurality of sets of channel gains.

7. The method of claim 5, further comprising:
transmitting, to the second device, a plurality of reference signals using each antenna subarray of the first quantity of antenna subarrays within the first circular antenna array of the first device; and
receiving, from the second device, an indication of a plurality of sets of channel gains based at least in part on the plurality of reference signals, each set of channel gains of the plurality of sets of channel gains comprising channel gains between antenna subarrays of the second quantity of antenna subarrays within the second circular antenna array of the second device and antenna subarrays of the first quantity of antenna subarrays within the first circular antenna array of the first device, and wherein the combining is based at least in part on the plurality of sets of channel gains.

8. The method of claim 1, wherein:
each antenna subarray of the first quantity of antenna subarrays within the first circular antenna array of the first device is located at a respective first angular offset relative to a first axis that bisects the first circular antenna array; and
each antenna subarray of the second quantity of antenna subarrays within the second circular antenna array of the second device is located at a respective second angular offset relative to a second axis that bisects the second circular antenna array and is parallel to the first axis, each respective second angular offset different than each respective first angular offset, wherein a difference between the respective first angular offset for a first antenna subarray of the first quantity of antenna subarrays and the respective second angular offset for a second antenna subarray of the second quantity of antenna subarrays is based at least in part on the first quantity of antenna subarrays and the second quantity of antenna subarrays.

9. The method of claim 8, wherein the difference is based at least in part on a ratio between the first quantity and a minimum of the first quantity and the second quantity.

10. The method of claim 1, further comprising:
transmitting, to the second device, signaling that indicates the first quantity of antenna subarrays within the first circular antenna array of the first device; or
receiving, from the second device, signaling that indicates the second quantity of antenna subarrays within the second circular antenna array of the second device; or
any combination thereof.

11. The method of claim 1, further comprising:
determining the first quantity of antenna subarrays of the first circular antenna array based at least in part on a condition of a channel between the first device and the second device, a type of the first device, a capability of the first device, power consumption of the first device, or any combination thereof.

12. A method for wireless communication at a second device, comprising:
receiving one or more signals from a first device using a second circular antenna array that comprises a second quantity of antenna subarrays, wherein each antenna subarray of the second circular antenna array comprises one or more antenna elements; and
decoding the one or more signals received using the second circular antenna array based at least in part on a plurality of orbital angular momentum vectors, wherein each signal of the one or more signals is associated with a respective orbital angular momentum vector of the plurality of orbital angular momentum vectors, and wherein the plurality of orbital angular momentum vectors is based at least in part on a first circular antenna array at the first device comprising a first quantity of antenna subarrays that is different than the second quantity of antenna subarrays included in the second circular antenna array.

13. The method of claim 12, wherein the plurality of orbital angular momentum vectors is based at least in part on the first quantity of antenna subarrays included in the first circular antenna array being an integer multiple of the second quantity of antenna subarrays included in the second circular antenna array or the second quantity of antenna subarrays included in the second circular antenna array being an integer multiple of the first quantity of antenna subarrays included in the first circular antenna array.

14. The method of claim 12, wherein a quantity of orbital angular momentum vectors within the plurality of orbital angular momentum vectors is equal to a minimum of the first quantity and the second quantity.

15. The method of claim 12, wherein:
the second quantity of antenna subarrays of the second circular antenna array is less than the first quantity of antenna subarrays of the first circular antenna array; and
each orbital angular momentum vector of the plurality of orbital angular momentum vectors comprises a respective orbital angular momentum weight for each antenna subarray of the second quantity of antenna subarrays based at least in part on the second quantity of antenna subarrays being less than the first quantity of antenna subarrays.

16. The method of claim 12, wherein the second quantity of antenna subarrays is equal to a product of the first quantity of antenna subarrays and an integer factor, the method further comprising:
grouping a second plurality of orbital angular momentum vectors into one or more groups based at least in part on the integer factor, wherein each group of the one or more groups comprises a same quantity of orbital angular momentum vectors, the same quantity equal to the integer factor; and
combining orbital angular momentum vectors in each group to obtain the plurality of orbital angular momentum vectors.

17. The method of claim 16, further comprising:
receiving, from the first device, a plurality of reference signals using each antenna subarray of the second quantity of antenna subarrays within the second circular antenna array of the second device; and
estimating a plurality of sets of channel gains based at least in part on the plurality of reference signals, the plurality of sets of channel gains comprising channel gains between antenna subarrays of the first quantity of antenna subarrays within the first circular antenna array of the first device and antenna subarrays of the second quantity of antenna subarrays within the second circular antenna array of the second device, and wherein the combining is based at least in part on the plurality of sets of channel gains.

18. The method of claim 16, further comprising:
transmitting, to the first device, a plurality of reference signals using each antenna subarray of the second quantity of antenna subarrays within the second circular antenna array of the second device; and
receiving, from the first device, an indication of a plurality of sets of channel gains based at least in part on the plurality of reference signals, each set of channel gains of the plurality of sets of channel gains comprising channel gains between antenna subarrays of the first quantity of antenna subarrays within the first circular antenna array of the first device and antenna subarrays of the second quantity within the second circular antenna array of the second device, and wherein the combining is based at least in part on the plurality of sets of channel gains.

19. The method of claim 12, wherein:
each antenna subarray of the first quantity of antenna subarrays within the first circular antenna array of the first device is located at a respective first angular offset relative to a first axis that bisects the first circular antenna array; and
each antenna subarray of the second quantity of antenna subarrays within the second circular antenna array of the second device is located at a respective second angular offset relative to a second axis that bisects the second circular antenna array and is parallel to the first axis, each respective second angular offset different than each respective first angular offset, wherein a difference between the respective first angular offset for a first antenna subarray of the first quantity of antenna subarrays and the respective second angular offset for a second antenna subarray of the second quantity of antenna subarrays is based at least in part on the first quantity of antenna subarrays and the second quantity of antenna subarrays.

20. The method of claim 19, wherein the difference is based at least in part on a ratio between the first quantity and a minimum of the first quantity and the second quantity.

21. The method of claim 12, further comprising:
transmitting, to the first device, signaling that indicates the second quantity of antenna subarrays within the second circular antenna array of the second device; or
receiving, from the first device, signaling that indicates the first quantity of antenna subarrays within the first circular antenna array of the first device; or
any combination thereof.

22. The method of claim 12, further comprising:
determining the second quantity of antenna subarrays of the second circular antenna array based at least in part on a condition of a channel between the second device and the first device, a type of the second device, a capability of the second device, power consumption of the second device, or any combination thereof.

23. An apparatus for wireless communication, comprising:
a processor of a first device;
a first circular antenna array that comprises a first quantity of antenna subarrays, wherein each antenna subarray of the first circular antenna array comprises one or more antenna elements; and
memory coupled with the processor, the memory and the processor configured to cause the apparatus to:
generate one or more signals for transmission from the first device to a second device via the first circular antenna array; and
transmit the one or more signals to the second device using the first circular antenna array and based at least in part on a plurality of orbital angular momentum vectors, wherein each signal of the one or more signals is associated with a respective orbital angular momentum vector of the plurality of orbital angular momentum vectors, and wherein the plurality of orbital angular momentum vectors is based at least in part on a second circular antenna array at the second device comprising a second quantity of antenna subarrays that is different than the first quantity of antenna subarrays included in the first circular antenna array.

24. The apparatus of claim 23, wherein the plurality of orbital angular momentum vectors is based at least in part on the first quantity of antenna subarrays included in the first circular antenna array being an integer multiple of the second quantity of antenna subarrays included in the second circular antenna array or the second quantity of antenna subarrays included in the second circular antenna array being an integer multiple of the first quantity of antenna subarrays included in the first circular antenna array.

25. The apparatus of claim 23, wherein:
the first quantity of antenna subarrays of the first circular antenna array is less than the second quantity of antenna subarrays of the second circular antenna array; and
each orbital angular momentum vector of the plurality of orbital angular momentum vectors comprises a respective orbital angular momentum weight for each antenna array of the first quantity of antenna subarrays based at least in part on the first quantity of antenna subarrays being less than the second quantity of antenna subarrays.

26. The apparatus of claim 23, wherein the memory and the processor are further configured to cause the apparatus to:
transmit, to the first device, signaling that indicates the second quantity of antenna subarrays within the second circular antenna array of the second device; or
receive, from the first device, signaling that indicates the first quantity of antenna subarrays within the first circular antenna array of the first device; or
any combination thereof.

27. An apparatus for wireless communication, comprising:
a processor of a second device;
a second circular antenna array that comprises a second quantity of antenna subarrays disposed in a circle, wherein each antenna subarray of the second circular antenna array comprises one or more antenna elements; and
memory coupled with the processor, the memory and the processor configured to cause the apparatus to:
receive one or more signals from a first device using the second circular antenna array; and
decode the one or more signals received using the second circular antenna array based at least in part on a plurality of orbital angular momentum vectors, wherein each signal of the one or more signals is associated with a respective orbital angular momentum vector of the plurality of orbital angular momentum vectors, and wherein the plurality of orbital angular momentum vectors is based at least in part on a first circular antenna array at the first device comprising a first quantity of antenna subarrays that is different than the second quantity of antenna subarrays included in the second circular antenna array.

28. The apparatus of claim 27, wherein the plurality of orbital angular momentum vectors is based at least in part on the first quantity of antenna subarrays included in the first circular antenna array being an integer multiple of the second quantity of antenna subarrays included in the second circular antenna array or the second quantity of antenna subarrays included in the second circular antenna array being an integer multiple of the first quantity of antenna subarrays included in the first circular antenna array.

29. The apparatus of claim 27, wherein:
the second quantity of antenna subarrays of the second circular antenna array is less than the first quantity of antenna subarrays of the first circular antenna array; and
each orbital angular momentum vector of the plurality of orbital angular momentum vectors comprises a respective orbital angular momentum weight for each antenna subarray of the second quantity of antenna subarrays based at least in part on the second quantity of antenna subarrays being less than the first quantity of antenna subarrays.

30. The apparatus of claim 27, wherein the memory and the processor are further configured to:
transmit, to the first device, signaling that indicates the second quantity of antenna subarrays within the second circular antenna array of the second device; or
receive, from the first device, signaling that indicates the first quantity of antenna subarrays within the first circular antenna array of the first device; or
any combination thereof.
